(19) United States
(12) Patent Application Publication
(10) Pub. No.: US 2025/0297045 A1
(43) Pub. Date: Sep. 25, 2025

(54) RESIN COMPOSITION, ADHESIVE MEMBER, AND DISPLAY DEVICE INCLUDING THE ADHESIVE MEMBER

(71) Applicant: Samsung Display Co., Ltd., Yongin-si (KR)

(72) Inventor: Koki IKUTA, Yokohama (JP)

(21) Appl. No.: 18/989,812

(22) Filed: Dec. 20, 2024

(30) Foreign Application Priority Data
Mar. 22, 2024 (KR) 10-2024-0039766

(51) Int. Cl. C08F 222/10; C08F 2/50; C08F 220/18; C08F 220/20; C08F 220/28; C08G 83/00; C09J 4/00; C09J 133/10

(52) U.S. Cl. CPC C08F 222/1065; C08F 2/50; C08F 220/1808; C08F 220/20; C08F 220/281; C08F 220/282; C08G 83/003; C09J 4/00; C09J 133/10; C09J 2203/318; C09J 2433/00

(57) ABSTRACT

A resin composition includes at least one monofunctional (meth)acrylate monomer, a urethane (meth)acrylate oligomer having a weight average molecular weight of approximately (about) 5,000 to approximately (about) 100,000, a dendritic polymer, and at least one photoinitiator including a radical polymerization initiator. The resin composition may exhibit low-viscosity properties before being cured, and may exhibit a storage modulus of approximately (about) 1 MPa or less at a frequency of approximately (about) 1 Hz and a temperature of approximately (about) −20° C., a 180° peel force of approximately (about) 800 gf/25 mm or greater with respect to at least one of a glass substrate or a polymer substrate at a temperature of approximately (about) 25° C., and a glass transition temperature of 0° C. or less, after being cured.

### CROSS-REFERENCE TO RELATED APPLICATION

The present application claims priority to and the benefit of Korean Patent Application No. 10-2024-0039766, filed on Mar. 22, 2024, in the Korean Intellectual Property Office, the entire disclosure of which is incorporated herein by reference.

### BACKGROUND

### 1. Field

One or more embodiments of the present disclosure relate to a resin composition including a dendritic polymer, an adhesive member formed from the resin composition, and a display device including the adhesive member.

### 2. Description of the Related Art

Various display devices used for multimedia devices, such as televisions, mobile phones, tablet computers, and/or game consoles, are being developed and continuously improved. For example, in recent years, in order to facilitate or enhance portability and improve user convenience, there has been active development of display devices with bendable and/or flexible display members, thereby making the display devices foldable, bendable, and/or rollable. An adhesive resin used for forming an adhesive layer that is applied to display devices (with various suitable shapes and/or types) is desired and/or required to have excellent or suitable coating properties with respect to members of various suitable types (e.g., kinds and/or shapes) of display devices. In other words, the adhesive resin used to form an adhesive layer for different shapes and/or types of display devices needs to have excellent coating properties suitable for various components of these devices.

### SUMMARY

One or more aspects of embodiments of the present disclosure are directed toward a resin composition exhibiting low-viscosity properties before being cured, and exhibiting a low modulus and high adhesion after being cured, an adhesive member formed from the resin composition, and a display device including the adhesive member.

Additional aspects will be set forth in part in the description which follows and, in part, will be apparent from the description, or may be learned by practice of the presented embodiments.

According to one or more embodiments of the disclosure, a resin composition includes at least one monofunctional (meth)acrylate monomer, a urethane (meth)acrylate oligomer having a weight average molecular weight of approximately (about) 5,000 to approximately (about) 100,000, a dendritic polymer, and at least one photoinitiator including a radical polymerization initiator.

In one or more embodiments, based on 100 wt % of a total weight of the resin composition, a weight of the dendritic polymer may be in a range of approximately (about) 0.5 wt % to approximately (about) 15 wt %.

In one or more embodiments, a glass transition temperature of the dendritic polymer may be in a range of approximately (about) 25° C. to approximately (about) 180° C.

In one or more embodiments, a weight average molecular weight of the dendritic polymer may be in a range of approximately (about) 1,000 to approximately (about) 50,000.

In one or more embodiments, the dendritic polymer may include a repeating unit represented by Formula 1.

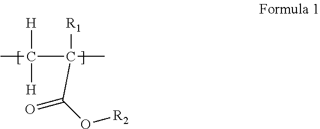

In Formula 1, R₁ may be hydrogen or a methyl group, and R₂ may be an alkyl group having 1 to 20 carbon atoms.

In one or more embodiments, the dendritic polymer may include a polyfunctional thiol moiety.

In one or more embodiments, a polydispersity index of the dendritic polymer may be in a range of approximately (about) 1.0 to approximately (about) 3.0.

In one or more embodiments, the resin composition may not include (e.g., may exclude) a (e.g., any) solvent.

In one or more embodiments, the resin composition may have a shear viscosity of approximately (about) 5 mPa-s to approximately (about) 50 mPa·s as measured by the JIS Z8803 method at a temperature of approximately (about) 25° C.

In one or more embodiments, after photo-curing, the photo-cured resin composition may have a storage modulus of approximately (about) 1 MPa or less at a frequency of approximately (about) 1 Hz and a temperature of approximately (about) −20° C.

In one or more embodiments, after photo-curing, the photo-cured resin composition may have a 180° peel force of approximately (about) 800 gf/25 mm or greater with respect to at least one of a glass substrate or a polymer substrate at a temperature of approximately (about) 25° C.

In one or more embodiments, after photo-curing, the photo-cured resin composition may have a glass transition temperature of 0° C. or less.

In one or more embodiments, the at least monofunctional (meth)acrylate monomer include at least one of 4-hydroxybutyl acrylate (4-HBA), 2-ethylhexyl acrylate (2-EHA), tetrahydrofurfuryl acrylate (THF-A), or 2-ethylhexyl-diglycol acrylate (EHDG-AT).

In one or more embodiments, the resin composition may be provided by an inkjet printing method or a dispensing method.

According to one or more embodiments of the disclosure, an adhesive member includes a polymer derived from a resin composition including at least one monofunctional (meth)acrylate monomer, a urethane (meth)acrylate oligomer having a weight average molecular weight of approximately (about) 5,000 to approximately (about) 100,000, a dendritic polymer, and at least one photoinitiator including a radical polymerization initiator.

In one or more embodiments, the adhesive member may have a storage modulus of approximately (about) 1 MPa or less at a frequency of approximately (about) 1 Hz and a temperature of approximately (about) −20° C.

In one or more embodiments, the adhesive member may have a 180° peel force of approximately (about) 800 gf/25 mm or greater with respect to at least one of a glass substrate or a polymer substrate at a temperature of approximately (about) 25° C.

In one or more embodiments, the adhesive member may have a glass transition temperature of approximately (about) 0° C. or less.

In one or more embodiments, based on 100 wt % of a total weight of the resin composition, a weight of the dendritic polymer may be in a range of approximately (about) 0.5 wt % to approximately (about) 15 wt %.

In one or more embodiments, a weight average molecular weight of the dendritic polymer may be in a range of approximately (about) 1,000 to approximately (about) 50,000.

In one or more embodiments, the dendritic polymer may include a repeating unit represented by Formula 1.

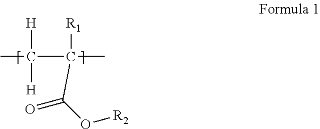

In Formula, R₁ may be hydrogen or a methyl group, and R₂ may be an alkyl group having 1 to 20 carbon atoms.

In one or more embodiments, the dendritic polymer may include a polyfunctional thiol moiety.

In one or more embodiments, the dendritic polymer may include a (meth)acrylate copolymer, wherein the (meth)acrylate copolymer may have a polydispersity index of approximately (about) 1.0 to approximately (about) 3.0.

In one or more embodiments, the resin composition may have a shear viscosity of approximately (about) 5 mPa·s to approximately (about) 50 mPa·s as measured by the JIS Z8803 method at a temperature of approximately (about) 25° C.

According to one or more embodiments of the disclosure, a display device includes a display panel, a window on the display panel, and an adhesive member between the display panel and the window and including a polymer derived from a resin composition containing at least one monofunctional (meth)acrylate monomer, a urethane (meth)acrylate oligomer having a weight average molecular weight of approximately (about) 5,000 to approximately (about) 100,000, a dendritic polymer, and at least one photoinitiator including a radical polymerization initiator.

In one or more embodiments, the adhesive member may have a storage modulus of approximately (about) 1 MPa or less at a frequency of approximately (about) 1 Hz and a temperature of approximately (about) −20° C.

In one or more embodiments, the adhesive member may have a 180° peel force of approximately (about) 800 gf/25 mm or greater with respect to at least one of a glass substrate or a polymer substrate at a temperature of approximately (about) 25° C.

In one or more embodiments, the adhesive member may have a glass transition temperature of approximately (about) 0° C. or less.

In one or more embodiments, based on 100 wt % of a total weight of the resin composition, a weight of the dendritic polymer may be in a range of approximately (about) 0.5 wt % to approximately (about) 15 wt %.

In one or more embodiments, a weight average molecular weight of the dendritic polymer may be in a range of approximately (about) 1,000 to approximately (about) 50,000.

In one or more embodiments, the dendritic polymer may include a repeating unit represented by Formula 1.

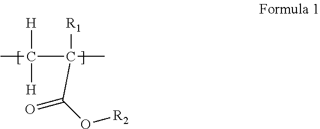

In Formula 1, R₁ may be hydrogen or a methyl group, and R₂ may be an alkyl group having 1 to 20 carbon atoms.

In one or more embodiments, the dendritic polymer may include a polyfunctional thiol moiety.

In one or more embodiments, the dendritic polymer may include a (meth)acrylate copolymer, wherein the (meth)acrylate copolymer may have a polydispersity index of approximately (about) 1.0 to approximately (about) 3.0.

In one or more embodiments, the resin composition may have a shear viscosity of approximately (about) 5 mPa·s to approximately (about) 50 mPa·s as measured by the JIS Z8803 method at a temperature of approximately (about) 25° C.

In one or more embodiments, the display device may further include an input sensing unit between the display panel and the window, wherein the adhesive member may be arranged between the display panel and the input sensing unit or between the input sensing unit and the window.

### BRIEF DESCRIPTION OF DRAWINGS

The accompanying drawings are included to provide a further understanding of the disclosure, and are incorporated in and constitute a part of this disclosure. The drawings illustrate embodiments of the present disclosure and, together with the description, serve to explain principles of the disclosure. Above and/or other aspects of the present disclosure should become apparent and appreciated from the following description of embodiments taken in conjunction with the accompanying drawings. In the drawings:

FIG. 1A is a perspective view showing a display device of one or more embodiments of the present disclosure;

FIG. 1B is a perspective view showing a display device of one or more embodiments of the present disclosure;

FIG. 1C is a plan view showing a display device of one or more embodiments of the present disclosure;

FIG. 1D is a perspective view showing a display device of one or more embodiments of the present disclosure;

FIG. 2 is an exploded perspective view showing a display device of one or more embodiments of the present disclosure;

FIG. 3 is a cross-sectional view showing a portion corresponding to line I-I′ of FIG. 2;

FIG. 4 is a cross-sectional view showing a portion of a display device according to one or more embodiments of the present disclosure;

FIG. 5A is a view schematically showing a method for preparing an adhesive member of one or more embodiments of the present disclosure;

FIG. 5B is a view schematically showing a method for preparing an adhesive member of one or more embodiments of the present disclosure;

FIG. 5C is a view schematically showing a method for preparing an adhesive member of one or more embodiments of the present disclosure;

FIG. 5D is a view schematically showing a method for preparing an adhesive member of one or more embodiments of the present disclosure;

FIG. 6A is a view schematically showing a method for preparing an adhesive member of one or more embodiments of the disclosure;

FIG. 6B is a view schematically showing a method for preparing an adhesive member of one or more embodiments of the present disclosure;

FIG. 6C is a view schematically showing a method for preparing an adhesive member of one or more embodiments of the present disclosure;

FIG. 7 is a cross-sectional view showing a display device of one or more embodiments of the present disclosure; and

FIG. 8 is a cross-sectional view showing a display device of one or more embodiments of the present disclosure.

### DETAILED DESCRIPTION

Embodiments of the present disclosure may be modified and practiced in many alternate forms, and thus example embodiments will be exemplified in the drawings and described in more detail. It should be understood, however, that it is not intended to limit the disclosure to the particular forms disclosed, but rather, is intended to cover all modifications, equivalents, and alternatives falling within the spirit and scope of the disclosure.

In the present disclosure, if (e.g., when) an element (or a region, a layer, a portion, and/or the like) is referred to as being “on,” “connected to,” or “coupled to” another element, it refers to that the element may be directly arranged on/connected to/coupled to the other element, or that a third element may be arranged therebetween. In contrast, when an element is referred to as being “directly on,” “directly connected to,” or “directly coupled to” another element, there are no intervening elements present therebetween.

In the present disclosure, like reference numerals refer to like elements. Also, in the drawings, the thickness, the ratio, and the dimensions of elements may be exaggerated for an effective description of technical contents. The term “and/or” or “or” may include any and all combinations of one or more of which associated elements may define.

It will be understood that, although the terms “first,” “second,” and/or the like, may be used herein to describe one or more suitable elements, these elements should not be limited by these terms. These terms are only used to distinguish one element from another. For example, a first element may be referred to as a second element, and a second element may also be referred to as a first element in a similar manner without departing the scope of rights of disclosure. As utilized herein, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure.”

In addition, terms such as “below,” “lower,” “above,” “upper,” and/or the like are used to describe the relationship of the elements shown in the drawings. The terms are used as a relative concept and are described with reference to the direction indicated in the drawings.

It should be understood that the term “comprise(s)/comprising,” “include(s)/including,” or “have (has)/having” is intended to specify the presence of stated features, integers, steps, operations, elements, components, and/or one or more (e.g., any suitable) combinations thereof in the disclosure, but do not preclude the presence or addition of one or more other features, integers, steps, operations, elements, components, and/or one or more (e.g., any suitable) combinations thereof.

Unless otherwise defined, all terms (including technical and scientific terms) used herein have the same meaning as commonly understood by one of ordinary skill in the art to which the disclosure pertains. It is also to be understood that terms such as terms defined in commonly used dictionaries should be interpreted as having meanings consistent with the meanings in the context of the related art, and should not be interpreted in too ideal a sense or an overly formal sense unless explicitly defined herein.

In the present disclosure, an alkyl group may be linear or branched. The number of carbon atoms of the alkyl group may be 1 to 50, 1 to 30, 1 to 20, 1 to 10, or 1 to 6. Examples of the alkyl group may include a methyl group, an ethyl group, an n-propyl group, an isopropyl group, an n-butyl group, an s-butyl group, a t-butyl group, an i-butyl group, a 2-ethylbutyl group, a 3,3-dimethylbutyl group, an n-pentyl group, an i-pentyl group, a neopentyl group, a t-pentyl group, a 1-methylpentyl group, a 3-methylpentyl group, a 2-ethylpentyl group, a 4-methyl-2-pentyl group, an n-hexyl group, a 1-methylhexyl group, a 2-ethylhexyl group, a 2-butylhexyl group, an n-heptyl group, a 1-methylheptyl group, a 2,2-dimethylheptyl group, a 2-ethylheptyl group, a 2-butylheptyl group, an n-octyl group, a t-octyl group, a 2-ethyloctyl group, a 2-butyloctyl group, a 2-hexyloctyl group, a 3,7-dimethyloctyl group, an n-nonyl group, an n-decyl group, an adamantly group, a 2-ethyldecyl group, a 2-butyldecyl group, a 2-hexyldecyl group, a 2-octyldecyl group, an n-undecyl group, an n-dodecyl group, a 2-ethyldodecyl group, a 2-butyldodecyl group, a 2-hexyldodecyl group, a 2-octyldodecyl group, an n-tridecyl group, an n-tetradecyl group, an n-pentadecyl group, an n-hexadecyl group, a 2-ethylhexadecyl group, a 2-butylhexadecyl group, a 2-hexylhexadecyl group, a 2-octylhexadecyl group, an n-heptadecyl group, an n-octadecyl group, an n-nonadecyl group, an n-eicosyl group, a 2-ethyleicosyl group, a 2-butyleicosyl group, a 2-hexyleicosyl group, a 2-octyleicosyl group, an n-heneicosyl group, an n-docosyl group, an n-tricosyl group, an n-tetracosyl group, an n-pentacosyl group, an n-hexacosyl group, an n-heptacosyl group, an n-octacosyl group, an n-nonacosyl group, and an n-triacontyl group, and/or the like, but embodiments of the present are not limited thereto.

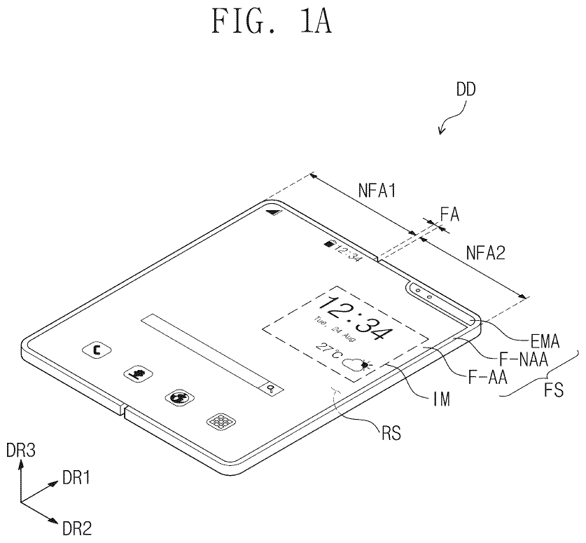

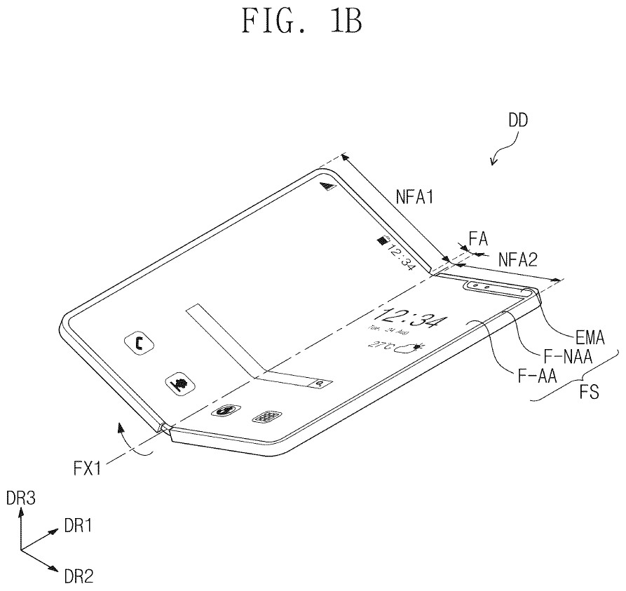

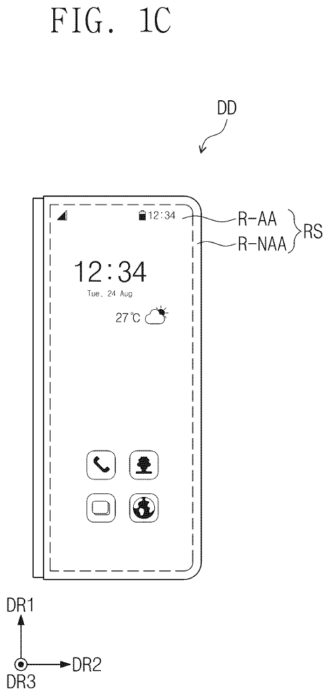

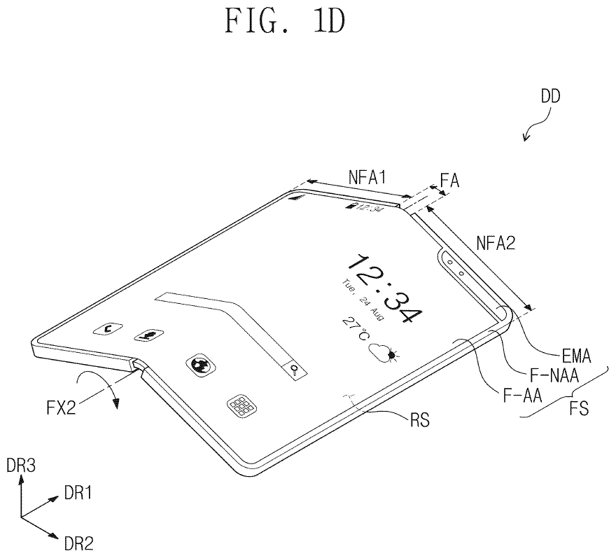

Hereinafter, with reference to the accompanying drawings, an adhesive member according to one or more embodiments of the disclosure, and a display device including the adhesive member will be described in more detail. FIG. 1A is a perspective view of a display device DD in an unfolded state according to one or more embodiments of the disclosure.

The display device DD of one or more embodiments may be a device activated by an electrical signal. For example, in one or more embodiments, the display device DD may be a mobile phone, a tablet, a car navigation system, a game console, or a wearable device, but embodiments of the present disclosure are not limited thereto. In FIG. 1A and as an example, the display device DD is illustrated as a mobile phone.

In one or more embodiments, the display device DD may include a first display surface FS defined by a first direction axis DR1 and a second direction axis DR2 intersecting the first direction axis DR1. The display device DD may provide an image IM to a user through the first display surface FS. The display device DD may display the image IM toward a third direction axis DR3 direction on the first display surface FS parallel to each of the first direction axis DR1 and the second direction axis DR2.

In the present disclosure, the first direction axis DR1 and the second direction axis DR2 are normal (e.g., perpendicular) to each other, and the third direction axis DR3 may be a normal direction with respect to a plane defined by the first direction axis DR1 and the second direction axis DR2. A thickness direction of the display device DD may be a direction parallel to the third direction axis DR3. A front surface (or upper surface) and a rear surface (or lower surface) oppose to the front surface in the third direction axis DR3, and the normal direction of each of the front surface (or upper surface) and the rear surface (or lower surface) may be parallel to the third direction axis DR3. The front surface (or upper surface) refers to a surface adjacent to the first display surface FS, and the rear surface (or lower surface) refers to a surface spaced and/or apart (e.g., spaced apart or separated) from the first display surface FS. In one or more embodiments, the rear surface (or lower surface) may refer to a surface close to a second display surface RS. An upper side refers to a direction getting closer to the first display surface FS, and a lower side refers to a direction moving away from the first display surface FS. In other words, the front (or upper) surface is near or close to the first display surface FS, while the rear (or lower) surface is further away (e.g., close to the second display surface RS), with the upper side closer to the first display surface FS and the lower side further from the first display surface FS.

A cross-section refers to a surface parallel to the thickness direction DR3, and a plane refers to a surface normal (e.g., perpendicular) to the thickness direction DR3. The plane refers to a plane defined by the first direction axis DR1 and the second direction axis DR2.

Directions indicated by the first to third direction axes DR1, DR2, and DR3 described in the present disclosure are a relative concept, and may be converted into different directions. In addition, the directions indicated by the first to third direction axes DR1, DR2, and DR3 may be described as first to third directions, respectively, and may be denoted by the same reference numerals.

The display device DD may sense an external input applied from the outside. The external input may include one or more suitable types (kinds) of inputs provided from the outside of the display device DD. For example, in one or more embodiments, the external input may include not only a contact by a part of a user's body, such as a hand, but also an external input (e.g., hovering) applied in close proximity, or adjacent to the display device DD at a set or predetermined distance. Also, the external input may have one or more suitable forms, such as force, pressure, temperature, light, and/or the like.

In one or more embodiments, the display device DD may include the first display surface FS and the second display surface RS. The first display surface FS may include a first active region F-AA, a first peripheral region F-NAA, and an electronic module region EMA. The second display surface RS may be defined as a surface opposing (e.g., opposite to) at least a portion of the first display surface FS. For example, the second display surface RS may be defined as a portion of a rear surface of the display device DD.

The first active region F-AA may be a region activated by an electrical signal. In one or more embodiments, the first active region F-AA may be a region in which the image IM is displayed, and which may sense an external input of one or more suitable forms.

The first peripheral region F-NAA may be adjacent to the first active region F-AA. The first peripheral region F-NAA may have a set or predetermined color. The first peripheral region F-NAA may be around (e.g., surround) the first active region F-AA. Accordingly, the shape of the first active region F-AA may be substantially defined by the first peripheral region F-NAA. However, this is only an example, and the first peripheral region F-NAA may be arranged adjacent to only one side of the first active region F-AA, or may not be provided.

In the electronic module region EMA, one or more suitable electronic modules may be provided and arranged. For example, in one or more embodiments, the electronic module may include at least one of a camera, a speaker, a light sensing sensor, or a heat sensing sensor. The electronic module region EMA may sense an external object by receiving a signal through the display surfaces FS and/or RS, or may provide a sound signal such as voice to the outside through the display surfaces FS and/or RS. The electronic module may include a plurality of components, and embodiments of the present disclosure are not limited thereto.

In one or more embodiments, the electronic module region EMA may be surrounded by the first peripheral region F-NAA. However, this is only an example, and embodiments of the present disclosure are not limited thereto. For example, in one or more embodiments, the electronic module region EMA may be surrounded by the first active region F-AA and the first peripheral region F-NAA, and the electronic module region EMA may be arranged inside the first active region F-AA.

The display device DD of one or more embodiments may be a flexible display device. The display device DD of one or more embodiments may include a (e.g., at least one) folding region FA and two or more (e.g., a plurality of) non-folding regions NFA1 and NFA2 extended from the folding region FA. For example, a first non-folding region NFA1, the folding region FA, and a second non-folding region NFA2 may be defined along the second direction DR2. In other words, along the second direction DR2, the display device includes the first non-folding region NFA1, the folding region FA, and the second non-folding region NFA2. The display device DD of one or more embodiments may include the first non-folding region NFA1 and the second non-folding region NFA2 spaced and/or apart (e.g., spaced apart or separated) from each other in the second direction DR2 with the folding region FA interposed therebetween. For example, in one or more embodiments, the first non-folding region NFA1 may be arranged on one side of the folding region FA along the second direction DR2, and the second non-folding region NFA2 may be arranged on the other side of the folding region FA along the second direction DR2.

In FIG. 1A and/or the like, one or more embodiments of the display device DD including one folding region FA are illustrated, but embodiments of the present disclosure are not limited thereto, and the display device DD may have a plurality of folding regions defined therein. For example, a display device according to one or more embodiments may include two or more folding regions, and may include three or more non-folding regions arranged with each of the folding regions interposed therebetween.

FIG. 1B is a perspective view showing a folding operation of the display device DD according to one or more embodiments of the present disclosure. FIG. 1C is a plan view of the display device DD in a folded state according to one or more embodiments of the present disclosure. FIG. 1D is a perspective view showing a folding operation of the display device DD according to one or more embodiments of the present disclosure.

Referring to FIG. 1B, the display device DD according to one or more embodiments may be folded based on (e.g., with respect to) a first folding axis FX1 extended in the first direction DR1. In a state in which the display device DD is folded, the folding region FA may have a set or predetermined curvature and a set or predetermined radius of curvature. The display device DD may be folded based on the first folding axis FX1 so as to be transformed into an in-folding state in which the first non-folding region NFA1 and the second non-folding region NFA2 face each other, and the first display surface FS is not exposed to the outside.

Referring to FIG. 1C, in the state in which the display device DD according to one or more embodiments is in-folded, the second display surface RS may be visually recognized by a user. In this regard, the second display surface RS may include a second active region R-AA which displays an image. The second active region R-AA may be a region activated by an electrical signal. The second active region R-AA may be a region in which an image is displayed, and which may sense an external input of one or more suitable forms.

A second peripheral region R-NAA may be adjacent to the second active region R-AA. The second peripheral region R-NAA may have a set or predetermined color. The second peripheral region R-NAA may be around (e.g., surround) the second active region R-AA. In one or more embodiments, the display device DD may further include an electronic module region in which an electronic module including one or more suitable components is also provided and arranged on the second display surface RS, but embodiments of the present disclosure are not limited thereto.

Referring to FIG. 1D, the display device DD according to one or more embodiments may be folded based on (e.g., with respect to) a second folding axis FX2 extended in the first direction DR1. The display device DD may be folded based on the second folding axis FX2 so as to be transformed into an out-folding state such that the first display surface FS is exposed to the outside. In one or more embodiments, the display device DD may be configured such that an in-folding operation or an out-folding operation may be alternately repeated from an un-folding operation, but embodiments of the present disclosure are not limited thereto.

In FIG. 1A to FIG. 1D, it is for example illustrated that folding is performed based on (e.g., with respect to) one of a folding axis FX1 or a folding axis FX2, but the number of folding axes and the number of non-folding regions in accordance therewith are not limited thereto. For example, in one or more embodiments, folding may be performed based on a plurality of folding axes such that a portion of each of the first display surface FS and the second display surface RS face each other. In addition, the first and second folding axes FX1 and FX2 are illustrated parallel to a long side of the display device DD, but embodiments of the present disclosure are not limited thereto, and the first and second folding axes FX1 and FX2 may be parallel to a short side of the display device DD.

In the display device DD, as illustrated in FIG. 1C, the first non-folding region NFA1 and the second non-folding region NFA2 may be respectively defined as portions having the display surfaces FS and RS which are parallel to the plane defined by the first direction axis DR1 and the second direction axis DR2 in a folded state, and the folding region FA may be defined as a region between the first non-folding region NFA1 and the second non-folding region NFA2. The folding region FA may include a curved surface portion which is bent to have a set or predetermined curvature in a folded state.

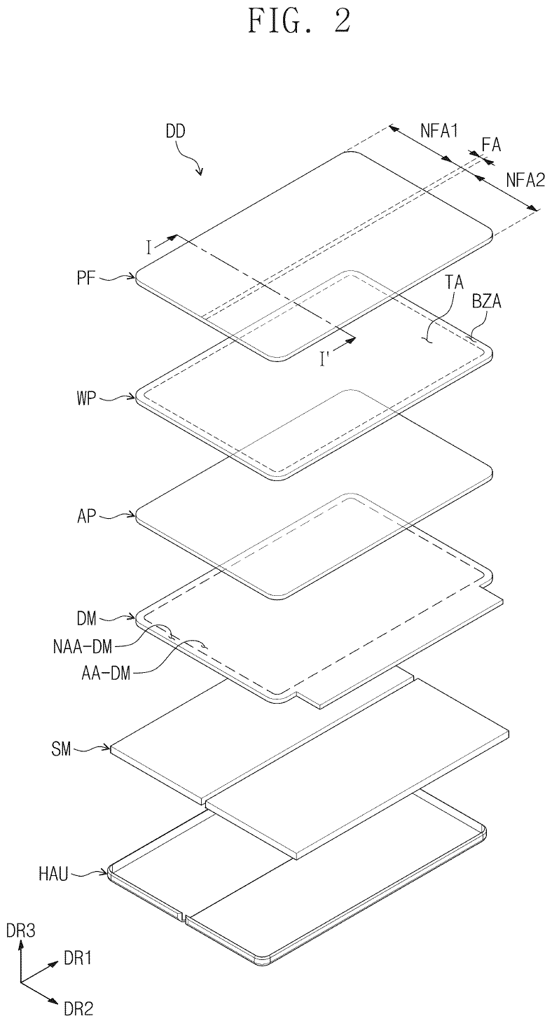

FIG. 2 is an exploded perspective view of the display device DD according to one or more embodiments of the present disclosure. Referring to FIG. 2, the display device DD may include a display module DM, a window WP on the display module DM, and an adhesive member AP between the display module DM and the window WP. In addition, the display device DD may further include a support member SM below the display module DM, a protective layer PF on the window WP, and a housing HAU accommodating the display module DM, the support member SM, and/or the like.

The housing HAU may include a material having relatively high rigidity. For example, in one or more embodiments, the housing HAU may include a plurality of frames and/or plates composed of glass, plastic, and/or a metal. The housing HAU may provide a set or predetermined accommodation space. The display module DM may be accommodated in the accommodation space to be protected from external impacts.

The support member SM may include a metal material and/or a polymer material. For example, in one or more embodiments, the support member SM may be formed by including stainless steel, aluminum, or an alloy thereof. In one or more embodiments, the support member SM may be formed of carbon fiber reinforced plastic (CFRP) and/or the like. However, embodiments of the present disclosure are not limited thereto, and the support member SM may include a non-metal material, plastic, glass fiber reinforced plastic, or glass. In some embodiments, the support member SM may not be provided.

In one or more embodiments, the display device DD may further include a cushion layer, a shielding layer, and/or the like below the support member SM. The cushion layer may include an elastomer and/or the like, such as a sponge, a foam, and/or a urethane resin. The shielding layer may be an electromagnetic wave shielding layer or a heat dissipating layer.

The display module DM may be activated by an electrical signal. The display module DM may be activated and display the image IM (see FIG. 1A) on the display surface FS (see FIG. 1A) of the display device DD. In the display module DM, a display region AA-DM and a non-display region NAA-DM may be defined. The display region AA-DM may be a region activated by an electrical signal. The non-display region NAA-DM may be a region positioned adjacent to at least one side of the display region AA-DM. In the non-display region NAA-DM, a circuit, a line, and/or the like for driving the display region AA-DM may be provided and arranged.

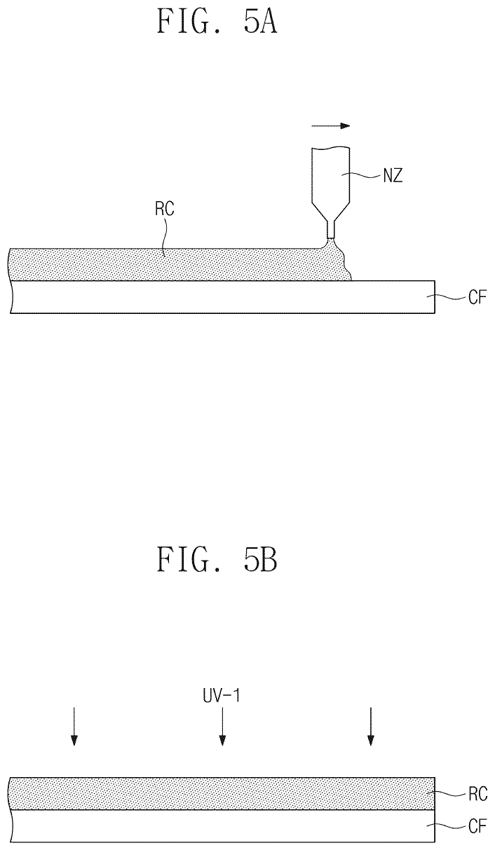

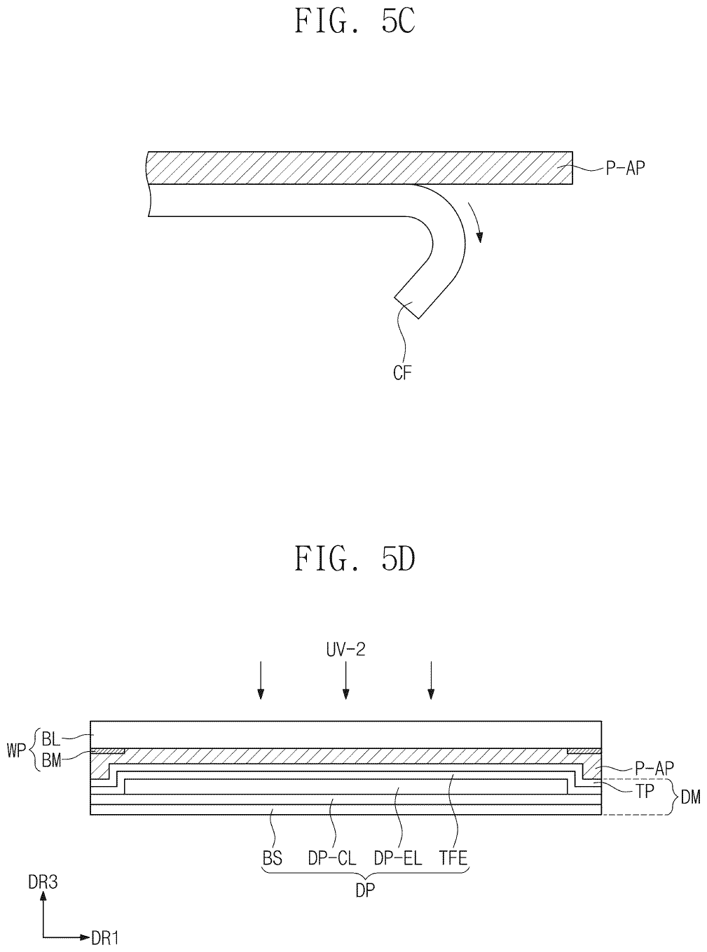

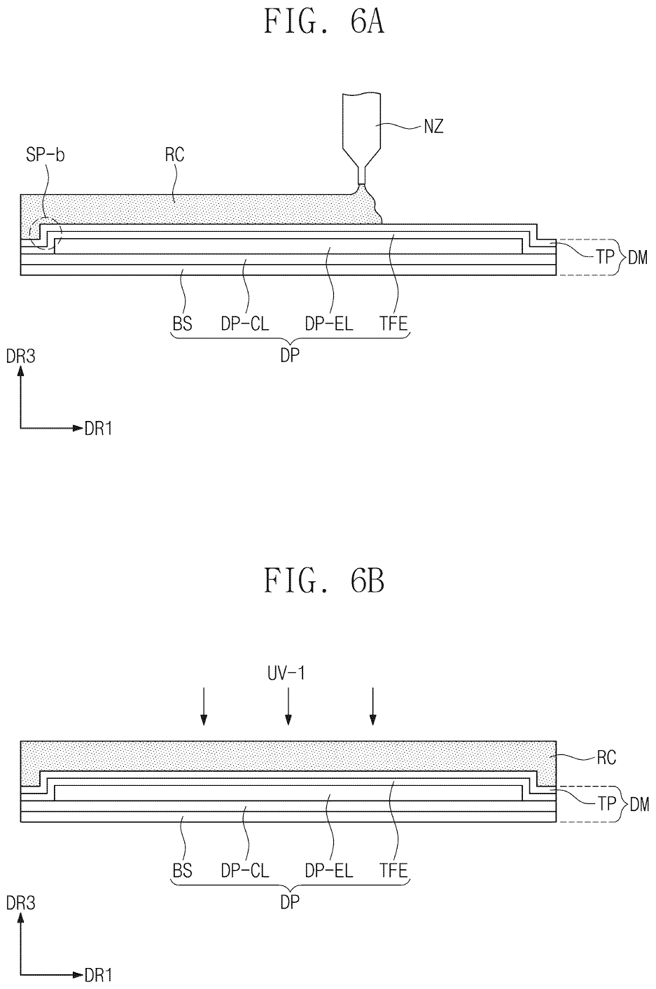

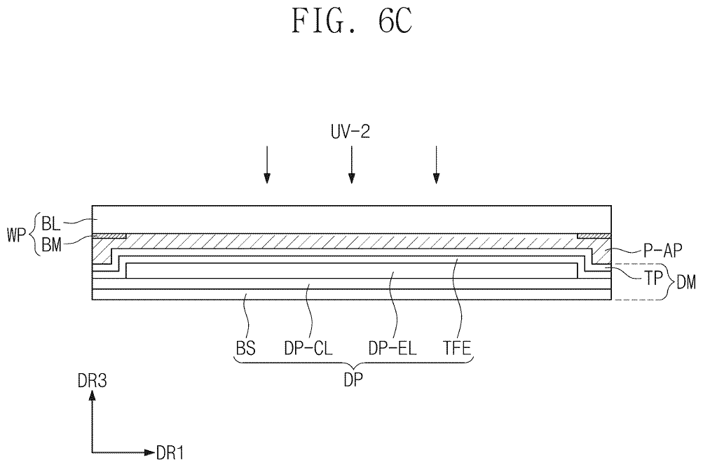

The adhesive member AP may be arranged on the display module DM. The display module DM and the window WP may be bonded by the adhesive member AP. The adhesive member AP may be optically transparent. The adhesive member AP of one or more embodiments may include a polymer derived from a resin composition RC (see FIG. 5A and FIG. 6A) of one or more embodiments of the present disclosure to be described later. The adhesive member AP may be formed from the resin composition RC (see FIG. 5A and FIG. 6A) of one or more embodiments. The adhesive member AP formed from the resin composition RC (see FIG. 5A and FIG. 6A) of one or more embodiments may exhibit excellent or suitable adhesion reliability. In one or more embodiments, the display device DD including the adhesive member AP formed from the resin composition RC (see FIG. 5A and FIG. 6A) may exhibit excellent or suitable reliability.

The window WP may include a glass substrate. The window WP may protect the display module DM, and/or the like. The image IM (see FIG. 1A) generated in the display module DM may be to transmit through the window WP and be provided to a user. For example, in one or more embodiments, the window WP may include an ultra-thin glass (UTG).

The window WP may include a transmissive region TA and a bezel region BZA. The transmissive region TA may overlap at least a portion of the display region AA-DM of the display module DM. The transmissive region TA may be an optically transparent region. The image IM (see FIG. 1A) may be provided to a user through the transmissive region TA.

The bezel region BZA may be a region having relatively a low light transmittance compared to the transmissive region TA. The bezel region BZA may define the shape of the transmissive region TA. The bezel region BZA may be adjacent to the transmissive region TA, and may be around (e.g., surround) the transmissive region TA.

The bezel region BZA may have a set or predetermined color. The bezel region BZA may cover the non-display region NAA-DM of the display module DM to prevent or reduce the non-display region NAA-DM from being visually recognized from the outside. However, embodiments of the present disclosure are not limited to what is illustrated, for example, the bezel region BZA may be arranged adjacent to only one side of the transmissive region TA, or may have at least a portion thereof omitted.

The protective layer PF may be a functional layer protecting one surface (e.g., an upper surface) of the window WP. The protective layer PF may include an anti-fingerprint coating agent, a hard coating agent, an anti-static agent, and/or the like. In one or more embodiments, an auxiliary adhesive layer may be further arranged between the window WP and the protective layer PF. In some embodiments, the protective layer PF may not be provided.

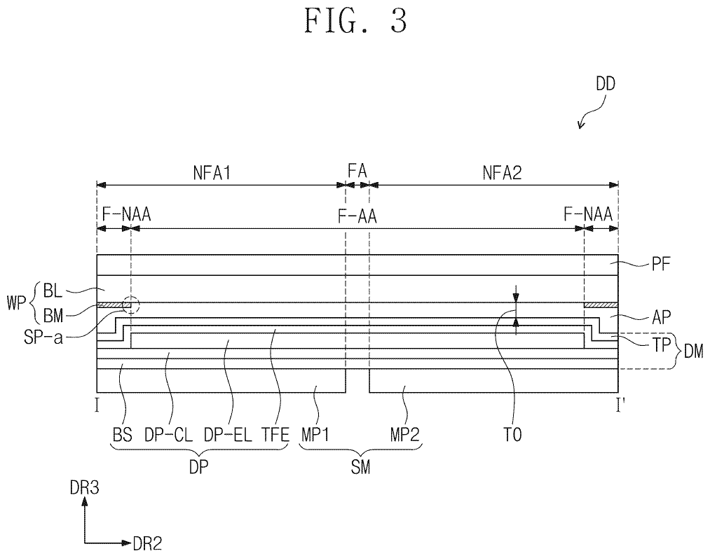

FIG. 3 is a cross-sectional view showing a portion corresponding to line I-I′ of FIG. 2. FIG. 3 may be a cross-sectional view showing the display device DD according to one or more embodiments of the present disclosure. In FIG. 3, for convenience of description, the housing HAU is omitted, and the support member SM, the display module DM, the adhesive member AP, the window WP, and the protective layer PF are illustrated.

Referring to FIG. 3, the support member SM may include a first support portion MP1 overlapping the first non-folding region NFA1 and a second support portion MP2 overlapping the second non-folding region NFA2. The first support portion MP1 and the second support portion MP2 may be spaced and/or apart (e.g., spaced apart or separated) in the folding region FA. In one or more embodiments, the first support portion MP1 and second support portion MP2 may not overlap the folding region FA. In one or more embodiments, at least a portion of the first support portion MP1 and at least a portion of the second support portion MP2 may each overlap the folding region FA.

The display module DM may include a display panel DP and an input sensing unit TP on the display panel DP. The display panel DP may include a base substrate BS, a circuit layer DP-CL on the base substrate BS, a display element layer DP-EL on the circuit layer DP-CL, and an encapsulation layer TFE covering the display element layer DP-EL. The adhesive member AP may be arranged between the display panel DP and the window WP.

The configuration of the display panel DP illustrated in FIG. 3 is merely an example, and the configuration of the display panel DP is not limited thereto. For example, in one or more embodiments, the display panel DP may include a liquid crystal display element, in which the encapsulation layer TFE may not be provided.

The base substrate BS may provide a base surface on which the circuit layer DP-CL is arranged. The base substrate BS may be a flexible substrate capable of bending, folding, rolling, and/or the like. The base substrate BS may be a glass substrate, a metal substrate, a polymer substrate, and/or the like. However, embodiments of the present disclosure are not limited thereto, and the base substrate BS may include an inorganic layer, an organic layer, or a composite material layer.

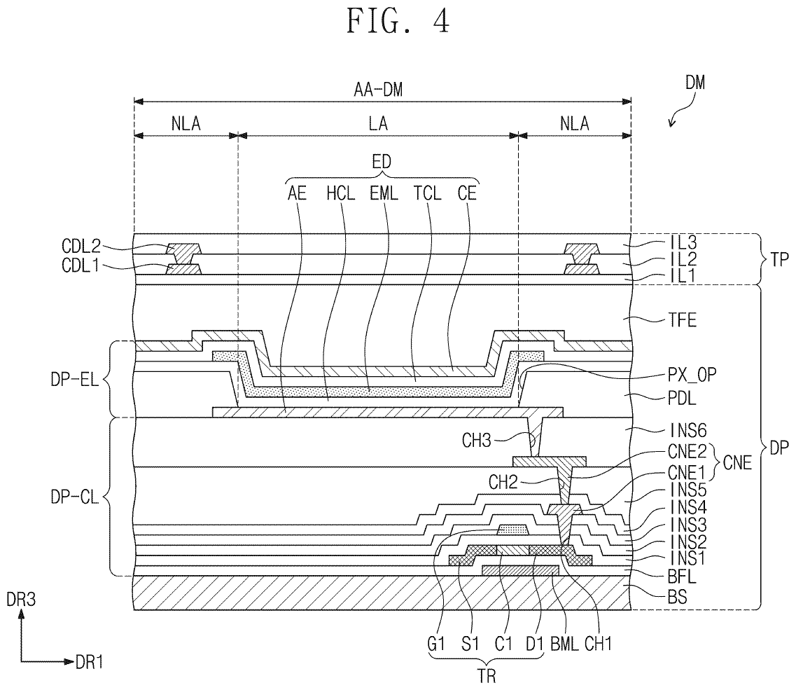

The circuit layer DP-CL may include an insulation layer, a semiconductor pattern, a conductive pattern, a signal (e.g., a signal circuit), and/or the like. For example, in one or more embodiments, the circuit layer DP-CL may include a switching transistor and a driving transistor for driving a light emitting element ED (see FIG. 4) of the display element layer DP-EL.

The display element layer DP-EL may include a light emitting element (see FIG. 4) for emitting light. For example, in one or more embodiments, the light emitting element (see FIG. 4) may include an organic light emitting material, an inorganic light emitting material, an organic-inorganic light emitting material, a quantum dot, a quantum rod, a micro-LED, or a nano-LED.

The encapsulation layer TFE may be arranged on the display element layer DP-EL. The encapsulation layer TFE may protect the display element layer DP-EL from foreign substances such as moisture, oxygen, and/or dust particles. In one or more embodiments, the encapsulation layer TFE may include at least one inorganic layer. In one or more embodiments, the encapsulation layer TFE may include at least one organic layer and at least one inorganic layer. For example, in some embodiments, the encapsulation layer TFE may include an inorganic layer, an organic layer, and an inorganic layer, which are sequentially stacked in the stated order.

The input sensing unit TP may be arranged on the display panel DP. For example, in one or more embodiments, the input sensing unit TP may be directly arranged on the encapsulation layer TFE of the display panel DP.

In the present disclosure, if (e.g., when) one element is directly arranged/provided on another element, it refers to that there is no third element arranged/provided between the one element and the another element. For example, if (e.g., when) one element is ‘directly arranged/provided’ on another element, it refers to that the one element and the another element are in ‘contact’ with each other. The input sensing unit TP may sense an external input and convert the external input into a set or predetermined input signal, and may provide the input signal to the display panel DP. For example, in the display device DD of one or more embodiments, the input sensing unit TP may be a touch sensing unit configured to sense a touch. The input sensing unit TP may recognize a direct touch of a user, an indirect touch of a user, a direct touch of an object, an indirect touch of an object, and/or the like.

The input sensing unit TP may sense at least one of a position of a touch applied externally or an intensity (pressure) of the touch. In one or more embodiments, the input sensing unit TP may have one or more suitable configurations or be composed of one or more suitable materials, but embodiments of the present disclosure are not limited thereto. For example, in one or more embodiments, the input sensing unit TP may sense an external input in a capacitive manner. The display panel DP may receive an input signal from the input sensing unit TP, and may generate an image corresponding to the input signal.

The window WP may include a base layer BL and a print layer BM. In one or more embodiments, the window WP may further include at least one functional layer provided on the base layer BL. For example, the functional layer may be a hard coating layer, an anti-fingerprint layer, and/or the like, but embodiments of the present disclosure are not limited thereto.

In one or more embodiments, the base layer BL may be a glass substrate. In one or more embodiments, the base layer BL may be a plastic substrate. For example, the base layer BL may be made of polyimide, polyacrylate, polymethylmethacrylate, polycarbonate, polyethylenenaphthalate, polyvinylidene chloride, polyvinylidene difluoride, polystyrene, an ethylene-vinylalcohol copolymer, and/or a (e.g., any suitable) combination thereof.

The print layer BM may be arranged on one surface of the base layer BL. In one or more embodiments, the print layer BM may be provided on a lower surface of the base layer BL adjacent to the display module DM. The print layer BM may be arranged in an edge region of the base layer BL. The print layer BM may be an ink print layer. In one or more embodiments, the print layer BM may be a layer formed by including a pigment and/or a dye. In the window WP, the bezel region BZA may be a portion in which the print layer BM is provided.

There may be a step SP-a present between the print layer BM and a portion of the base layer BL in which the print layer BM is not provided. The adhesive member AP formed from the resin composition RC (see FIGS. 5A and 5B) according to one or more embodiments has excellent or suitable flexibility and excellent or suitable adhesion, and thus, may be attached to the window WP without lifting in the step SP-a portion.

The adhesive member AP may be arranged between the display panel DP and the window WP. The adhesive member AP may be arranged between the input sensing unit TP arranged on the display panel DP and the window WP.

A thickness TO of the adhesive member AP may be in a range of approximately (about) 50 μm to approximately (about) 200 μm. For example, in one or more embodiments, the thickness TO of the adhesive member AP may be in a range of approximately (about) 50 μm to approximately (about) 100 μm. However, this is a mere example, and the thickness TO of the adhesive member AP is not limited thereto.

In one or more embodiments, the adhesive member AP may have a storage modulus of approximately (about) 1 MPa or less at a frequency of 1 Hz and a temperature of approximately (about) −20° C. In the present disclosure, the storage modulus is measured in a shear (torsion) mode. An adhesive member having a storage modulus of greater than 1 MPa at a frequency of 1 Hz and a temperature of −20° C. is vulnerable to external impacts and has very low flexibility, and thus, is not suitable for use in display devices. In contrast, the adhesive member AP of one or more embodiments having a storage modulus of 1 MPa or less at a frequency of 1 Hz and a temperature of −20° C. may exhibit excellent or suitable impact resistance and excellent or suitable flexibility. In one or more embodiments, the display device DD including the adhesive member AP of the present disclosure may exhibit excellent or suitable reliability. In other words, the adhesive member AP in one or more embodiments, with a storage modulus of 1 MPa or less at a frequency of 1 Hz and a temperature of −20° C., may exhibit excellent impact resistance and flexibility. Consequently, the display device DD including this adhesive member AP may have excellent reliability.

In one or more embodiments, the adhesive member AP may have a 180° peel force of approximately (about) 800 gf/25 mm or greater with respect to at least one of a glass substrate or a polymer substrate at a temperature of approximately (about) 25° C. The adhesive member AP may have a 180° peel force of approximately (about) 2100 gf/25 mm or less with respect to at least one of a glass substrate or a polymer substrate at a temperature of approximately (about) 25° C. For example, in one or more embodiments, the polymer substrate may include polyethylene terephthalate (PET). The adhesive member AP having a 180° peel force of approximately (about) 800 gf/25 mm or greater with respect to a glass substrate or a polymer substrate at a temperature of approximately (about) 25° C. may exhibit excellent or suitable adhesion reliability. The display device DD including the adhesive member AP having a 180° peel force of approximately (about) 800 gf/25 mm or greater with respect to a glass substrate or a polymer substrate at a temperature of approximately (about) 25° C. may exhibit excellent or suitable reliability. In contrast, an adhesive member having a 180° peel force of less than approximately (about) 800 gf/25 mm with respect to a glass substrate or a polymer substrate at a temperature of approximately (about) 25° C. has low adhesive force, and thus, if (e.g., when) included in a display device, the adhesive member is peeled off from a component (e.g., a display module and/or a window) of the display device.

In one or more embodiments, the adhesive member AP may have a 180° peel force of approximately (about) 500 gf/25 mm to approximately (about) 1200 gf/25 mm with respect to at least one of a glass substrate or a polymer substrate at a temperature of approximately (about) 60° C. However, this is only an example, and embodiments of the present disclosure are not limited thereto. For example, in one or more embodiments, the adhesive member AP may have a 180° peel force of about 800 gf/25 mm or greater at 25° C., and may have a 180° peel force of about 500 gf/25 mm to about 1200 gf/25 mm at 60° C.

In one or more embodiments, the adhesive member AP may have a glass transition temperature Tg of approximately (about) 0° C. or less. An adhesive member having a glass transition temperature of greater than approximately (about) 0° C. is not suitable for use in a display device because a polymer constituting the adhesive member has very high cohesiveness, and thus, is vulnerable to external impacts. In contrast, the adhesive member AP of one or more embodiments having a glass transition temperature of approximately (about) 0° C. or less may exhibit excellent or suitable impact resistance because a polymer constituting the adhesive member AP has desired or suitable cohesiveness. In one or more embodiments, the display device DD including the adhesive member AP having a glass transition temperature of approximately (about) 0° C. or less may exhibit excellent or suitable reliability.

For example, in one or more embodiments, the adhesive member AP may have a glass transition temperature of approximately (about) −32° C. or less. The adhesive member AP of one or more embodiments having a glass transition temperature of approximately (about) −32° C. or less may exhibit properties in which folding and unfolding may be easily repeated in a low-temperature environment. The adhesive member AP of one or more embodiments having a glass transition temperature of approximately (about) −32° C. or less may exhibit excellent or suitable properties for use in the flexible display device DD.

In one or more embodiments, the adhesive member AP may be formed from the resin composition RC (see FIG. 5A and FIG. 6A) of one or more embodiments. Accordingly, the adhesive member AP of one or more embodiments may satisfy the storage modulus, the 180° peel force, and the glass transition temperature, which are described above.

FIG. 4 is a cross-sectional view specifically showing the display module DM of FIG. 3. The configuration of the display module DM illustrated in FIG. 4 is only an example, and embodiments of the present disclosure are not limited thereto.

In FIG. 4, the base substrate BS may include a single layer or multiple layers. For example, in one or more embodiments, the base substrate BS may include a first synthetic resin layer, a multi-layered or single-layered inorganic layer, and a second synthetic resin layer on the multi-layered or single-layered inorganic layer. Each of the first synthetic resin layer and the second synthetic resin layer may include a polyimide-based resin. In one or more embodiments, each of the first synthetic resin layer and the second synthetic resin layer may include at least one of an acrylic resin, a methacrylic resin, a polyisoprene-based resin, a vinyl-based resin, an epoxy-based resin, a urethane-based resin, a cellulose-based resin, a siloxane-based resin, a polyamide-based resin, or a perylene-based resin. In the present disclosure, a “˜˜-based” resin refers to that a functional group of the “˜˜” is included.

The display panel DP may include a transistor TR and a light emitting element ED. The transistor TR and the light emitting element ED may each be arranged on the base substrate BS. FIG. 4 illustrates one transistor TR, but the display panel DP may include a plurality of transistors for substantially driving the light emitting element ED, and at least one capacitor.

The circuit layer DP-CL may be arranged on the base substrate BS. The circuit layer DP-CL may include a shielding electrode BML, the transistor TR, a connection electrode CNE, and a plurality of insulation layers BFL and INS1 to INS6. The plurality of insulation layers BFL and INS1 to INS6 may include a buffer layer BFL and first to sixth insulation layers INS1 to INS6. However, the stacking structure of the circuit layer DP-CL illustrated in FIG. 4 is only an example, and depending on the configuration of the display panel DP and the process of the circuit layer DP-CL, the stacking structure of the circuit layer DP-CL may change.

The shielding electrode BML may be arranged on the base substrate BS. The shielding electrode BML may overlap the transistor TR. The shielding electrode BML may protect the transistor TR by blocking light incident on the transistor TR from a lower portion of the display panel DP. The shielding electrode BML may include a conductive material (e.g., electron conductor). When a voltage is applied to the shielding electrode BML, the transistor TR arranged on the shielding electrode BML may maintain a threshold voltage. However, embodiments of the disclosure are not limited thereto, for example, the shielding electrode BML may be a floating electrode. In some embodiments, the shielding electrode BML may not be provided.

The buffer layer BFL may be arranged on the base substrate BS and cover the shielding electrode BML. The buffer layer BFL may include an inorganic layer. The buffer layer BFL may improve coupling force between a semiconductor pattern or conductive pattern arranged on the buffer layer BFL and the base substrate BS.

The transistor TR may include a source S1, channel C1, a drain D1, and a gate G1. The source S1, the channel C1, and the drain D1 of the transistor TR may each be formed from a semiconductor pattern. The semiconductor pattern of the transistor TR may include polysilicon, amorphous silicon, or a metal oxide, and is not limited to any one thereof as long as it has semiconductor properties.

The semiconductor pattern may include a plurality of regions distinguished according to the magnitude of conductivity. In the semiconductor pattern, a region which is doped with a dopant or in which a metal oxide is reduced may have high conductivity, and may substantially serve as a source electrode or a drain electrode of the transistor TR. In the semiconductor pattern, a region having high conductivity may correspond to the source S1 or the drain D1 of the transistor TR. In the semiconductor pattern, a region which is not doped or doped to a low concentration, or which has low conductivity due to non-reduction of a metal oxide may correspond to the channel C1 (or an active) of the transistor TR.

The first insulation layer INS1 may be arranged on the buffer layer BFL while covering the semiconductor pattern of the transistor TR. The gate G1 of the transistor TR may be arranged on the first insulation layer INS1. On a plane (e.g., in a plan view), the gate G1 may overlap the channel C1 of the transistor TR. The gate G1 may serve as a mask in a process of doping the semiconductor pattern of the transistor TR.

The second insulation layer INS2 may be arranged on the first insulation layer INS1 while covering the gate G1. The third insulation layer INS3 may be arranged on the second insulation layer INS2.

The connection electrode CNE may include a first connection electrode CNE1 and a second connection electrode CNE2 for electrically connecting the transistor TR and the light emitting element ED. However, the configuration of the connection electrode CNE electrically connecting the transistor TR and the light emitting element ED is not limited thereto, in one or more embodiments, one of the first and second connection electrodes CNE1 and CNE2 may not be provided, or an additional connection electrode may be further included.

The first connection electrode CNE1 may be arranged on the third insulation layer INS3. The first connection electrode CNE1 may be connected to the drain D1 via a first contact-hole CH1 passing through the first to third insulation layers INS1 to INS3. The fourth insulation layer INS4 may be arranged on the third insulation layer INS3 while covering the first connection electrode CNE1. The fifth insulation layer INS5 may be arranged on the fourth insulation layer INS4.

The second connection electrode CNE2 may be arranged on the fifth insulation layer INS5. The second connection electrode CNE2 may be connected to the first connection electrode CNE1 via a second contact-hole CH2 passing through the fourth and fifth insulation layers INS4 and INS5. The sixth insulation layer INS6 may be arranged on the fifth insulation layer INS5 while covering the second connection electrode CNE2.

Each of the first to sixth insulation layers INS1 to INS6 may include an inorganic layer or an organic layer. For example, the inorganic layer may include at least one of an aluminum oxide, a titanium oxide, a silicon oxide, a silicon oxynitride, a zirconium oxide, or a hafnium oxide. The organic layer may include at least of an acrylic resin, a methacrylic resin, a polyisoprene-based resin, a vinyl-based resin, an epoxy-based resin, a urethane-based resin, a cellulose-based resin, a siloxane-based resin, a polyamide-based resin, or a perylene-based resin.

The display element layer DP-EL may include a pixel definition film PDL and the light emitting element ED. The light emitting element ED may include a first electrode AE, a hole control layer HCL, a light emitting layer EML, an electron control layer TCL, and a second electrode CE.

The first electrode AE may be arranged on the sixth insulation layer INS6. The first electrode AE may be connected to the second connection electrode CNE2 via a third contact-hole CH3 passing through the sixth insulation layer INS6. The first electrode AE may be electrically connected to the drain D1 of the transistor TR via the first and second connection electrodes CNE1 and CNE2.

The first electrode AE may be formed of a metal material, a metal alloy, or a conductive compound. The first electrode AE may be an anode or a cathode. However, embodiments of the disclosure are not limited thereto. In addition, the first electrode AE may be a pixel electrode. The first electrode AE may be a transmissive electrode, a transflective electrode, or a reflective electrode. The first electrode AE may include at least one selected from among silver (Ag), magnesium (Mg), copper (Cu), aluminum (Al), platinum (Pt), palladium (Pd), gold (Au), nickel (Ni), neodymium (Nd), iridium (Ir), chromium (Cr), lithium (Li), calcium (Ca), lithium fluoride (LiF), molybdenum (Mo), titanium (Ti), tungsten (W), indium (In), tin (Sn), and zinc (Zn), a compound of two or more selected therefrom, a mixture of two or more selected therefrom, or an oxide thereof.

If (e.g., when) the first electrode AE is a transmissive electrode, the first electrode AE may include a transparent metal oxide, for example, indium tin oxide (ITO), indium zinc oxide (IZO), zinc oxide (ZnO), indium tin zinc oxide (ITZO), and/or the like. If (e.g., when) the first electrode AE is a transflective electrode or reflective electrode, the first electrode AE may include Ag, Mg, Cu, Al, Pt, Pd, Au, Ni, Nd, Ir, Cr, Li, Ca, LiF/Ca (stacked structure of LiF and Ca), LiF/Al (stacked structure of LiF and Al), Mo, Ti, W, or a compound or a mixture thereof (for example, a mixture of Ag and Mg). In one or more embodiments, the first electrode AE may have a multi-layered structure including a reflective film or a transflective film formed of one or more of the above exemplified materials, and a transparent conductive film formed of indium tin oxide (ITO), indium zinc oxide (IZO), zinc oxide (ZnO), indium tin zinc oxide (ITZO), and/or the like. For example, in one or more embodiments, the first electrode AE may have a three-layered structure of ITO/Ag/ITO, but embodiments of the present disclosure are not limited thereto. In one or more embodiments, the first electrode AE may include any one of the above-described metal materials, a combination of two or more metal materials selected from among the above-described metal materials, an oxide of any one of the above-described metal materials, and/or the like.

The pixel definition film PDL may be arranged on the sixth insulation layer INS6. On the pixel definition film PDL, a light emitting opening PX_OP exposing a portion of the first electrode AE may be defined. The portion of the first electrode AE exposed by the light emitting opening PX_OP may be defined as a light emitting region LA.

The display region AA-DM of the display module DM may include the light emitting region LA and a light blocking region NLA. A region in which the pixel definition film PDL is arranged may correspond to the light blocking region NLA. The light blocking region NLA may be around (e.g., surround) the light emitting region LA in the display region AA-DM.

The hole control layer HCL may be arranged on the first electrode AE and the pixel definition film PDL. In one or more embodiments, the hole control layer HCL may be provided as a common layer overlapping the light emitting region LA and the light blocking region NLA. In contrast, in one or more embodiments, the hole control layer HCL may be provided only in a region corresponding to the light emitting opening PX_OP. The hole control layer HCL may include at least one of a hole transport layer, a hole injection layer, or an electron blocking layer. The control layer HCL may include a hole injection material suitable in the art and/or a hole transport material suitable in the art.

The light emitting layer EML may be arranged on the hole control layer HCL. In one or more embodiments, the light emitting layer EML may be arranged in the region corresponding to the light emitting opening PX_OP. In contrast, in one or more embodiments, the light emitting layer EML may be provided as a common layer. The light emitting layer EML may include an organic light emitting material and/or an inorganic light emitting material. The light emitting layer EML may be to emit color light of any one of red, green, and blue colors. For example, in one or more embodiments, the light emitting layer EML may be to emit blue light.

The electron control layer TCL may be arranged on the light emitting layer EML. In one or more embodiments, the electron control layer TCL may be provided as a common layer overlapping the light emitting region LA and the light blocking region NLA. In contrast, in one or more embodiments, the electron control layer TCL may be provided only in the region corresponding to the light emitting opening PX_OP. The electron control layer TCL may include at least of an electron transport layer, an electron injection layer, or a hole blocking layer. The electron control layer TCL may include an electron injection material suitable in the art and/or an electron transport material suitable in the art.

The second electrode CE may be arranged on the electron control layer TCL. The second electrode CE may be provided as a common layer overlapping the light emitting region LA and the light blocking region NLA.

The second electrode CE may be a common electrode. The second electrode CE may be a cathode or an anode, but embodiments of the disclosure are not limited thereto. For example, if (e.g., when) the first electrode AE is an anode, the second electrode CE may be a cathode, and if (e.g., when) the first electrode AE is a cathode, the second electrode CE may be an anode.

The second electrode CE may be a transmissive electrode, a transflective electrode, or a reflective electrode. If (e.g., when) the second electrode CE is a transmissive electrode, the second electrode CE may be formed of a transparent metal oxide, for example, indium tin oxide (ITO), indium zinc oxide (IZO), zinc oxide (ZnO), indium tin zinc oxide (ITZO), and/or the like.

If (e.g., when) the second electrode CE is a transflective electrode or a reflective electrode, the second electrode CE may include Ag, Mg, Cu, Al, Pt, Pd, Au, Ni, Nd, Ir, Cr, Li, Ca, LiF/Ca, LiF/Al, Mo, Ti, Yb, W, or a compound or a mixture thereof (for example, AgMg, AgYb, or MgYb). In one or more embodiments, the second electrode CE may have a multi-layered structure including a reflective film or a transflective film formed of one or more of the above exemplified materials, and a transparent conductive film formed of indium tin oxide (ITO), indium zinc oxide (IZO), zinc oxide (ZnO), indium tin zinc oxide (ITZO), and/or the like. For example, in one or more embodiments, the second electrode CE may include any one of the above-described metal materials, a combination of two or more metal materials selected from among the above-described metal materials, an oxide of any one of the above-described metal materials, and/or the like.

The encapsulation layer TFE may be arranged on the second electrode CE and cover the light emitting element ED. The encapsulation layer TFE may include a plurality of thin films. For example, in one or more embodiments, the encapsulation layer TFE may include inorganic films arranged on the second electrode CE and an organic film arranged between the inorganic films. The inorganic film may protect the light emitting element ED from moisture and/or oxygen, and the organic film may protect the light emitting element ED from foreign substances such as dust particles.

The input sensing unit TP may include a first sensing insulation layer IL1, a second sensing insulation layer IL2, and a third sensing insulation layer IL3. The input sensing unit TP may include at least one conductive layer arranged on the sensing insulation layers. The input sensing unit TP may include a first conductive layer CDL1 and a second conductive layer CDL2.

The first sensing insulation layer IL1 may be arranged on the encapsulation layer TFE. The first sensing insulation layer IL1 may include at least one inorganic insulation layer. The first sensing insulation layer IL1 may contact the encapsulation layer TFE. In contrast, in some embodiments, the first sensing insulation layer IL1 may not be provided, in which case the first conductive layer CDL1 may contact the encapsulation layer TFE.

The first conductive layer CDL1 may be arranged on the first sensing insulation layer IL1. The first conductive layer CDL1 may include a plurality of first conductive patterns. The plurality of the first conductive patterns may be arranged on the first sensing insulation layer IL1. The second sensing insulation layer IL2 may be arranged on the first sensing insulation layer IL1 so as to cover at least a portion of the first conductive layer CDL1.

The second conductive layer CDL2 may be arranged on the second sensing insulation layer IL2. The second conductive layer CDL2 may include a plurality of second conductive patterns. The plurality of the second conductive patterns may be arranged on the second sensing insulation layer IL2. The plurality the second conductive patterns may be respectively connected to the plurality of the first conductive patterns via contact-hole formed on the second sensing insulation layer IL2.

The plurality of the first conductive patterns of the first conductive layer CDL1 and the plurality of the second conductive patterns of the second conductive layer CDL2 may each be arranged in correspondence to the light blocking region NLA. The plurality of the first conductive patterns of the first conductive layer CDL1 and the plurality of the second conductive patterns of the second conductive layer CDL2 may each correspond to a mesh pattern.

The third sensing insulation layer IL3 may be arranged on the second sensing insulation layer IL2, and may cover the second conductive layer CDL2. The second sensing insulation layer IL2 and the third sensing insulation layer IL3 may each include an inorganic insulation layer or an organic insulation layer.

Each of the first conductive layer CDL1 and the second conductive layer CDL2 may have a single-layered structure, or may have a multi-layered structure in which layers are stacked along the third direction DR3. The conductive layers CDL1 and CDL2 of a single-layered structure may each include a metal layer or a transparent conductive layer. The metal layer may include molybdenum, silver, titanium, copper, aluminum, or an alloy thereof. The transparent conductive layer may include a transparent conductive oxide such as indium tin oxide (ITO), indium zinc oxide (IZO), zinc oxide (ZnO), indium zinc tin oxide (IZTO), and/or the like. In one or more embodiments, the transparent conductive layer may include a conductive polymer such as poly(3,4-ethylenedioxythiophene) (PEDOT), a metal nanowire, graphene, and/or the like.

The conductive layers CDL1 and CDL2 of a multi-layered structure may each include metal layers. The metal layers may have, for example, a three-layered structure of titanium (Ti)/aluminum (Al)/titanium (Ti). In one or more embodiments, the conductive layers CDL1 and CDL2 of a multi-layered structure may each include at least one metal layer and at least one transparent conductive layer.

FIG. 5A to FIG. 5D are views schematically showing a method for preparing the adhesive member AP (see FIG. 3) from the resin composition RC of one or more embodiments. For example, in one or more embodiments, the method for preparing the adhesive member AP (see FIG. 3) may include providing the resin composition RC on a substrate CF, providing a first light UV-1 to the resin composition RC to form a preliminary adhesive member P-AP, and providing a second light UV-2 to the preliminary adhesive member P-AP to form the adhesive member AP (see FIG. 3). Hereinafter, in describing FIG. 5A to FIG. 5D, the same contents as those described with reference to FIG. 1 to FIG. 4 will not be described again, and instead, only differences will be mainly described.

Referring to FIG. 5A, the resin composition RC of one or more embodiments may be provided on the substrate CF. The resin composition RC may be provided on the substrate CF through a nozzle NZ. For example, the substrate CF on which the resin composition RC is provided may include polyethylene terephthalate (PET). The substrate CF is a temporary substrate used for forming the adhesive member AP (see FIG. 3) from the resin composition RC, and may be used without limitation as long as it can be easily detached after the resin composition RC is cured. One surface of the substrate CF on which the resin composition RC is provided may have been subjected to release treatment.

The resin composition RC of one or more embodiments may be provided by an inkjet printing method or a dispensing method. In one or more embodiments, the resin composition RC in a liquid phase may be provided in a substantially uniform amount and/or at a substantially uniform rate. FIG. 5A illustrates that the resin composition RC is provided through the nozzle NZ, but a device for providing the resin composition RC is not limited thereto.

The resin composition RC of one or more embodiments may have a shear viscosity of approximately (about) 5 mPa·s to approximately (about) 30 mPa·s as measured by the JIS Z8803 method at a temperature of approximately (about) 25° C. The resin composition RC having a shear viscosity of approximately (about) 5 mPa-s to approximately (about) 30 mPa·s as measured by the JIS Z8803 method at a temperature of approximately (about) 25° C. exhibits low-viscosity properties, and thus, may be provided by an inkjet printing method or a dispensing method. When a resin composition having a shear viscosity of less than approximately (about) 5 mPa·s as measured by the JIS Z8803 method at a temperature of approximately (about) 25° C. is provided, a flow occurs. The ‘flow’ refers to a phenomenon in which a resin composition flows out of a member to which the resin composition is to be provided. A resin composition having a shear viscosity of greater than approximately (about) 50 mPa·s as measured by the JIS Z8803 method at a temperature of approximately (about) 25° C. is not easily discharged from a device such as the nozzle NZ, and is not applied in a uniform amount and/or to a uniform thickness. The entire disclosure of JIS Z 8803, Methods for Viscosity Measurement of Liquid, is incorporated herein by reference.

The resin composition RC of one or more embodiments may include at least one monofunctional (meth)acrylate monomer, a urethane (meth)acrylate oligomer having a weight average molecular weight of approximately (about) 5,000 to approximately (about) 100,000, a dendritic polymer, and at least one photoinitiator. In one or more embodiments, the photoinitiator may include a radical polymerization initiator. In the present disclosure, a (meth)acryloyl group refers to an acryloyl group or a methacryloyl group, and (meth)acryl refers to acryl or methacryl.

The resin composition RC may include at least one monofunctional (meth)acrylate monomer. For example, based on a total weight of 100 wt % (weight percent) of the resin composition, a weight of the monofunctional (meth)acrylate monomer may be in a range of approximately (about) 75 wt % to approximately (about) 85 wt %. However, this is only an example, and the weight of the monofunctional (meth)acrylate monomer is not limited thereto.

The monofunctional (meth)acrylate monomer may include at least one of an alicyclic (meth)acrylate, a hydroxyl group-containing (meth)acrylate, an alkyl (meth)acrylate, or an aromatic (meth)acrylate. For example, in one or more embodiments, the monofunctional (meth)acrylate monomer may include at least one of 4-hydroxybutyl acrylate (4-HBA), 2-ethylhexyl acrylate (2-EHA), tetrahydrofurfuryl acrylate (THF-A), or 2-ethylhexyl-diglycol acrylate (EHDG-AT).

The resin composition RC of one or more embodiments may include at least one urethane (meth)acrylate oligomer. The urethane (meth)acrylate oligomer may have a weight average molecular weight of approximately (about) 5,000 to approximately (about) 100,000. The urethane (meth)acrylate oligomer having a weight average molecular weight of approximately (about) 5,000 to approximately (about) 100,000 is included in the resin composition RC while having a relatively high degree of polymerization, thereby maintaining a high degree of polymerization even after photo-curing, and thus, may form the adhesive member AP having excellent or suitable adhesion reliability.

For example, in one or more embodiments, based on the total weight of 100 wt % of the resin composition RC, a weight of the urethane (meth)acrylate oligomer may be in a range of approximately (about) 10 wt % to approximately (about) 15 wt %. in one or more embodiments, based on the total weight of 100 wt % of the resin composition RC, the weight of the urethane (meth)acrylate oligomer may be in a range of approximately (about) 11 wt % to approximately (about) 13 wt %. However, this is only an example, and the weight of the urethane (meth)acrylate oligomer is not limited thereto.

In one or more embodiments, in the resin composition RC, the urethane (meth)acrylate oligomer may include at least one of UF-C051 (urethane acrylate, a product of Kyoeisha Chemical Co., Ltd), UF-C052 (urethane acrylate, a product of Kyoeisha Chemical Co., Ltd), or UN6304 (urethane acrylate, a product of Negami Chemical Industrial Co., Ltd). However, this is only an example, and the urethane (meth)acrylate oligomer included in the resin composition RC is not limited thereto.

The resin composition RC of one or more embodiments may include a dendritic polymer. The dendritic polymer refers to a polymer having a ‘dendritic structure,’ and the ‘dendritic structure’ refers to a structure including a core portion and an arm portion directly or indirectly bonded to the core portion. The core portion may be composed of a single element or a plurality of elements. The arm portion may be composed of a plurality of elements.

A resin composition including a polymer may be selectively segregated at an interface with air during curing of the resin composition to increase cohesion of the interface. The resin composition RC of one or more embodiments includes a dendritic polymer, thereby reducing entanglement between polymer chains or between the polymer and a matrix monomer, and thus, may be efficiently segregated at an interface. Therefore, the adhesive member AP formed from the resin composition RC of one or more embodiments including a dendritic polymer may exhibit relaxed stiffness. In addition, in one or more embodiments, the adhesive member AP (see FIG. 3) formed from the resin composition RC including a dendritic polymer may satisfy the storage modulus, the 180° peel force, and the glass transition temperature, which are described above.

Based on the total weight of 100 wt % of the resin composition RC, a weight of the dendritic polymer may be in a range of approximately (about) 0.5 wt % to approximately (about) 15 wt %. An adhesive member formed from a resin composition including a dendritic polymer of less than approximately (about) 0.5 wt % based on the total weight of 100 wt % of the resin composition exhibits a low 180° peel force, and thus, is not suitable for use in flexible display devices. An adhesive member formed from a resin composition including a dendritic polymer of greater than approximately (about) 15 wt % based on the total weight of 100 wt % of the resin composition exhibits a high modulus, and thus, exhibits low shape retention. In contrast, in one or more embodiments, the adhesive member AP (see FIG. 3) formed from the resin composition RC including a dendritic polymer of approximately (about) 0.5 wt % to approximately (about) 15 wt % based on the total weight of 100 wt % of the resin composition RC exhibits excellent or suitable shape retention, and may exhibit properties suitable for use in flexible display devices.

In one or more embodiments, a weight average molecular weight of the dendritic polymer may be in a range of approximately (about) 1,000 to approximately (about) 50,000. For example, in one or more embodiments, the weight average molecular weight of the dendritic polymer may be in a range of approximately (about) 5,000 to approximately (about) 30,000. The resin composition RC including a dendritic polymer having a weight average molecular weight of approximately (about) 1,000 to approximately (about) 50,000 satisfies the above-described shear viscosity, and the adhesive member AP (see FIG. 3) formed from the resin composition RC may satisfy the storage modulus, the 180° peel force, and the glass transition temperature, which are described above. In the present disclosure, the weight average molecular weight of the dendritic polymer or the urethane (meth)acrylate oligomer may be measured by gel permeation chromatography (GPC).

In one or more embodiments, a glass transition temperature of the dendritic polymer may be in a range of approximately (about) 25° C. to approximately (about) 180° C. For example, in one or more embodiments, the glass transition temperature of the dendritic polymer may be in a range of approximately (about) 50° C. to approximately (about) 150° C., or approximately (about) 80° C. to approximately (about) 120° C. The resin composition RC including a dendritic polymer having a glass transition temperature of approximately (about) 25° C. to approximately (about) 180° C. satisfies the above-described shear viscosity, and the adhesive member AP (see FIG. 3) formed from the resin composition RC may satisfy the storage modulus, the 180° peel force, and the glass transition temperature, which are described above.

In one or more embodiments, the dendritic polymer may have a polydispersity index (PDI) of approximately (about) 1.0 to approximately (about) 3.0. The polydispersity index is a value obtained by dividing a weight average molecular weight (Mw) by a number average molecular weight (Mn). The larger the polydispersity index value, the wider the polydispersity index from a low molecular weight to a high molecular weight, and the smaller the polydispersity index value, the narrower the polydispersity index from a low molecular weight to a high molecular weight. The resin composition RC including a dendritic polymer having a polydispersity index of approximately (about) 1.0 to approximately (about) 3.0 satisfies the above-described shear viscosity, and the adhesive member AP (see FIG. 3) formed from the resin composition RC may satisfy the storage modulus, the 180° peel force, and the glass transition temperature, which are described above. In the present disclosure, the polydispersity index of a polymer may be measure by gel permeation chromatography (GPC).

In one or more embodiments, the dendritic polymer may include a (meth)acrylate copolymer. In one or more embodiments, the dendritic polymer may include a copolymer composed of a first repeating unit derived from a first monomer and a second repeating unit derived from a second monomer. For example, the first monomer may contain methyl methacrylate (MMA) and the second monomer may contain isobornyl methacrylate (IBXMA).

In one or more embodiments, the dendritic polymer may include a polyfunctional thiol moiety. A thiol moiety refers to a certain compound or structure derived from a compound including a thiol group (—SH). In one or more embodiments, the dendritic polymer may be synthesized by a radical polymerization method using a polyfunctional initiator and/or a radical polymerization method using a polyfunctional chain transfer agent. A free radical polymerization method using a polyfunctional chain transfer agent including a polyfunctional thiol moiety may exhibit excellent or suitable efficiency due to the richness in types (kinds) of polyfunctional thiol moieties and the ease of synthesis.

In one or more embodiments, the dendritic polymer may include a repeating unit represented by Formula 1. In one or more embodiments, the dendritic polymer may include a repeating unit including an ester group. The resin composition RC including a dendritic polymer including a repeating unit represented by Formula 1 satisfies the above-described shear viscosity, and the adhesive member AP (see FIG. 3) formed from the resin composition RC may satisfy the storage modulus, the 180° peel force, and the glass transition temperature, which are described above.

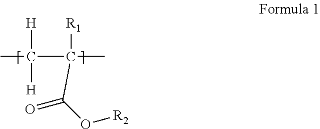

In Formula 1, R₁ may be hydrogen or a methyl group, and R₂ may be an alkyl group having 1 to 20 carbon atoms. The alkyl group may be a straight-chain alkyl group or branched-chain alkyl groups.

The resin composition RC of one or more embodiments may include at least one photoinitiator. The photoinitiator may include a radical polymerization initiator. For example, in one or more embodiments, the resin composition RC may include bis(2,4,6-trimethylbenzoyl)-phenylphosphine oxide (Omnirad 819) (a product of IGM Resin Co.) as a photoinitiator.

If (e.g., when) the resin composition RC includes a plurality of photoinitiators, different photoinitiators may be activated by ultraviolet light with different center wavelengths. For example, the photoinitiator may include at least one of 2,2-dimethoxy-1,2-diphenylethan-1-one, 1-hydroxy-cyclohexyl-phenylketone, 2-hydroxy-2-methyl-1-phenyl-1-propanone, 2-hydroxy-1-[4-(2-hydroxyethoxy)phenyl]-2-methyl-1-propanone, or 2-hydroxy-1-{4-[4-(2-hydroxy-2-methyl-propionyl)-benzyl]-phenyl}-2-methylpropan-1-one.

In addition, the photoinitiator may include at least one of 2-methyl-1 [4-(methylthio)phenyl]-2-morpholinopropan-1-one, 2-benzyl-2-dimethylamino-1-(4-morpholinophenyl)-butanone-1,2-dimethylamino-2-(4-methyl-benzyl)-1-(4-morpholin-4-yl-phenyl)-butan-1-one, 2,4,6-trimethylbenzoyl-diphenylphosphine oxide, ethyl(2,4,6-trimethylbenzoyl)phenyl phosphinate, phenylbis(2,4,6-trimethylbenzoyl) phosphine oxide, [1-(4-phenylsulfanylbenzoyl) heptylideneamino]benzoate, 2-methylbenzoyl) carbazol-3-yl]ethylideneamino]acetate, or bis(2,4-cyclopentadienyl)bis [2,6-difluoro-3-(pyrrol-1-yl)phenyl] titanium (IV).

In one or more embodiments, the resin composition R may not include (e.g., may exclude) a (e.g., any) solvent. A solvent refers to a liquid for dissolving materials constituting a composition (e.g., a monomer, an oligomer, and/or the like). A resin composition including a solvent requires drying time and/or the like after the resin composition is applied. In contrast, the resin composition RC of one or more embodiments not including a solvent does not require drying time and/or the like after the resin composition RC is applied, and may be provided by an inkjet printing method or a dispensing method, and thus, may exhibit excellent or suitable preparation efficiency.

Referring to FIG. 5B, the first light UV-1 may be provided to the resin composition RC applied to a set or predetermined thickness on the substrate CF. The resin composition RC in a liquid phase may be cured by the first light UV-1 to form a preliminary adhesive member P-AP (see FIG. 5C). The first light UV-1 may be ultraviolet light. FIG. 5B illustrates that the resin composition RC applied on the substrate CF is directly irradiated with the first light UV-1, thereby forming the preliminary adhesive member P-AP, but embodiments of the disclosure are not limited thereto. In one or more embodiments, a carrier film may be arranged on the resin composition RC applied to a substantially uniform thickness, and the carrier film may be transmit ultraviolet light (e.g., transparent to ultraviolet light).

Referring to FIG. 5C and FIG. 5D, the preliminary adhesive member P-AP formed by irradiating the resin composition RC with the first light UV-1 (see FIG. 5B) may be detached from the substrate CF, and provided on one surface of the window WP or one surface of the display module DM. One surface of the preliminary adhesive member P-AP may be laminated on one surface of the window WP or one surface of the display module DM, and to the other surface of the preliminary adhesive member P-AP, an unattached one surface of the display module DM or an unattached one surface of the window WP may be attached. Thereafter, the preliminary adhesive member P-AP may be irradiated with the second light UV-2, thereby forming the adhesive member AP (see FIG. 3). The second light UV-2 may be ultraviolet light. The second light UV-2 may be provided from an upper portion of the window WP, and the window WP may be to transmit the second light UV-2 (e.g., transparent to the second light UV-2). The second light UV-2 may be to transmit the window WP and be provided to the preliminary adhesive member P-AP.

In one or more embodiments, FIG. 5A to FIG. 5D illustrates that the resin composition RC is cured twice (i.e., cured by being provided with light twice) to form the adhesive member AP (see FIG. 3), but embodiments of the disclosure are not limited thereto. For example, the resin composition RC (see FIG. 5A) may be cure once to form the adhesive member AP (see FIG. 3), or may be cured three or more times to form the adhesive member AP (see FIG. 3).

The resin composition RC (see FIG. 5A) of one or more embodiments may include at least one monofunctional (meth)acrylate monomer, a urethane (meth)acrylate oligomer having a weight average molecular weight of approximately (about) 5,000 to approximately (about) 100,000, a dendritic polymer, and at least one photoinitiator including a radical polymerization initiator. The resin composition RC (see FIG. 5A) of one or more embodiments may be cured by the light UV-1 and UV-2. For example, the resin composition RC (FIG. 5A) may be cured by ultraviolet light to form the adhesive member AP (FIG. 3). After being cured by light, the resin composition RC (FIG. 5A) of one or more embodiments may have a storage modulus of approximately (about) 1 MPa or less at a frequency of approximately (about) 1 Hz and a temperature of approximately (about) −20° C. After being cured by light, the resin composition RC (see FIG. 5A) of one or more embodiments may have a 180° peel force of approximately (about) 800 gf/25 mm or greater with respect to at least one of a glass substrate or a polymer substrate at a temperature of approximately (about) 25° C. After being cured by light, the resin composition RC (FIG. 5A) of one or more embodiments may have a glass transition temperature of approximately (about) 0° C. or less. For example, after being cured by light, the resin composition RC (FIG. 5A) of one or more embodiments may have a glass transition temperature of approximately (about) −32° C. or less. The resin composition RC (see FIG. 5A) of one or more embodiments includes a monofunctional (meth)acrylate monomer, a urethane (meth)acrylate oligomer, a dendritic polymer, and a radical polymerization initiator, and thus, may satisfy the storage modulus, the 180° peel force, and the glass transition temperature, which are described above.

FIG. 6A to FIG. 6C are views schematically showing another method for preparing the adhesive member AP from the resin composition RC of one or more embodiments. Hereinafter, in describing FIG. 6A to FIG. 6C, the same (or similar) contents as (or to) those described with reference to FIG. 1 to FIG. 5D will not be described again, and instead, only differences will be mainly described.

The method for preparing the adhesive member AP illustrated in FIG. 6A to FIG. 6D may include providing the resin composition RC on a display module DM, providing a first light UV-1 to the resin composition RC to form a preliminary adhesive member P-AP, and providing a second light UV-2 to the preliminary adhesive member P-AP to form an adhesive member AP. When compared to the preparation method illustrated in FIG. 5A to FIG. 5D, the preparation method illustrated in FIG. 6A to FIG. 6C is different in that the resin composition RC is provided on the display module DM.

The resin composition RC may be provided directly on one surface of the display module DM or on one surface of a window WP. In FIG. 6A, the resin composition RC is illustrated as being provided directly on one surface of the display module DM.

The resin composition RC having a shear viscosity of approximately (about) 5 mPa·s to approximately (about) 50 mPa·s as measured by the JIS Z8803 method at a temperature of approximately (about) 25° C. may be provided while covering the curve of a step SP-b portion in the display module DM. The resin composition RC has a low shear viscosity of approximately (about) 50 mPa-s or less, and thus, may be applied leaving no empty space in a portion having a curve such as the step SP-b. In addition, the resin composition RC having a shear viscosity of approximately (about) 5 mPa-s or greater may be uniformly (e.g., substantially uniformly) applied to a set or predetermined thickness without flowing out of a portion to which the resin composition RC is to be provided, that is, the display module DM.

Referring to FIG. 6B, the first light UV-1 may be provided to the resin composition RC uniformly (e.g., substantially uniformly) applied. As the first light UV-1 is provided to the resin composition RC, the preliminary adhesive member P-AP may be formed. Referring to FIG. 6C, the window WP may be provided on the preliminary adhesive member P-AP. The second light UV-2 may be to transmit the window WP and be provided to the preliminary adhesive member P-AP. The preliminary adhesive member P-AP may be cured by the second light UV-2 to form the adhesive member AP (see FIG. 3).

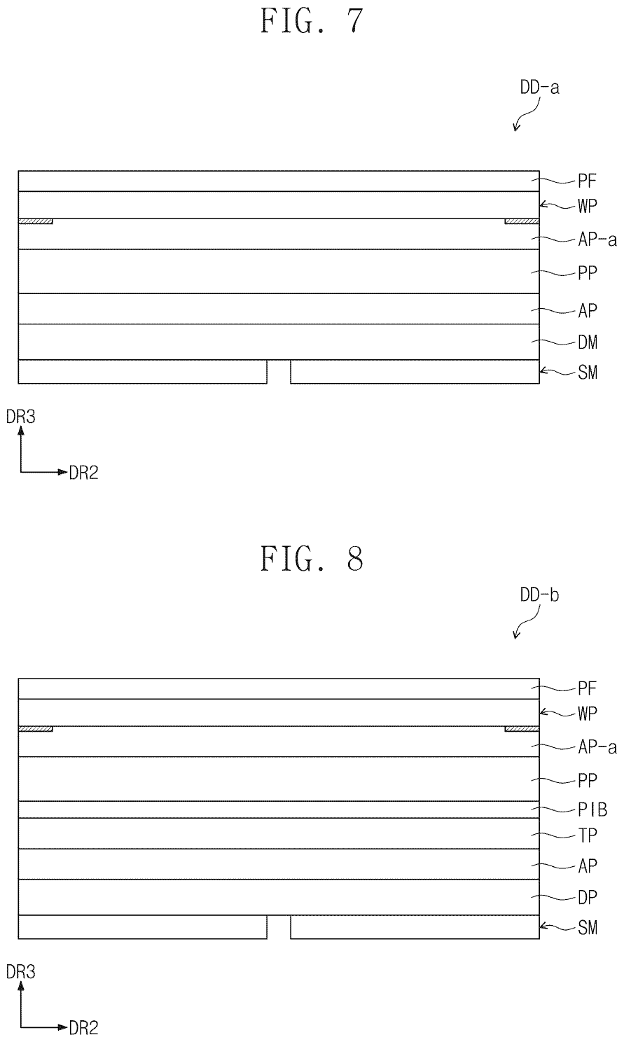

FIG. 7 is a cross-sectional view showing a display device according to one or more embodiments of the disclosure. Hereinafter, in describing the display device illustrated in FIG. 7, the same (or similar) contents as (or to) those described with reference to FIG. 1A to FIG. 6C will not be described again, and instead, only differences will be mainly described.

Compared to the display device DD described with reference to FIG. 2 and FIG. 3, a display device DD-a illustrated in FIG. 7 may further include a light control layer PP and an optical adhesive layer AP-a. The display device DD-a of one or more embodiments may further include the light control layer PP between the adhesive member AP and the window WP, and the optical adhesive layer AP-a arranged between the light control layer PP and the window WP. The light control layer PP may include a polarizing plate and/or a color filter layer.

The optical adhesive layer AP-a may be formed from the resin composition RC (see FIG. 5A and FIG. 6A) of one or more embodiments. The optical adhesive layer AP-a including a polymer derived from the resin composition RC (see FIG. 5A and FIG. 6A) of one or more embodiments may have a storage modulus of approximately (about) 1 MPa or less at a frequency of approximately (about) 1 Hz and a temperature of approximately (about) −20° C. The optical adhesive layer AP-a including a polymer derived from the resin composition RC (see FIG. 5A and FIG. 6A) of one or more embodiments may have a 180° peel force of approximately (about) 800 gf/25 mm or greater with respect to at least one of a glass substrate or a polymer substrate at a temperature of approximately (about) 25° C. The optical adhesive layer AP-a including a polymer derived from the resin composition RC (see FIG. 5A and FIG. 6A) of one or more embodiments may have a glass transition temperature of approximately (about) 0° C. or less. For example, in one or more embodiments, the optical adhesive layer AP-a including a polymer derived from the resin composition RC (see FIG. 5A and FIG. 6A) of one or more embodiments may have a glass transition temperature of approximately (about) −32° C. or less. The optical adhesive layer AP-a including a polymer derived from the resin composition RC (see FIG. 5A and FIG. 6A) of one or more embodiments may exhibit excellent or suitable flexibility and excellent or suitable adhesion reliability.

FIG. 8 is a cross-sectional view showing a display device according to one or more embodiments of the disclosure. Hereinafter, in describing the display device of one or more embodiments illustrated in FIG. 8, the same (or similar) contents as (or to) those described above with reference to FIGS. 1 to 7 will not be described again, and instead, only differences will be mainly described.

Compared to the display device DD described with reference to FIG. 2 and FIG. 3, a display device DD-b of one or more embodiments illustrated in FIG. 8 may further include a light control layer PP, an optical adhesive layer AP-a, and an interlayer adhesive layer PIB. The display device DD-b of one or more embodiments illustrated in FIG. 8 may further include the light control layer PP between the adhesive member AP and the window WP, and the optical adhesive layer AP-a between the light control layer PP and the window WP, as in the case of the display device DD-a of one or more embodiments illustrated in FIG. 7.

In the display device DD-b of one or more embodiments, the adhesive member AP may be provided between the display panel DP and the input sensing unit TP. For example, in one or more embodiments, the input sensing unit TP is not arranged directly on the display panel DP, but instead, the display panel DP and the input sensing unit TP may be bonded to each other by the adhesive member AP. For example, in one or more embodiments, the adhesive member AP may be arranged between the encapsulation layer TFE (see FIG. 3) of the display panel DP and the input sensing unit TP.

On a lower side of the light control layer PP, an interlayer adhesive layer PIB may be provided. In one or more embodiments, the interlayer adhesive layer PIB is arranged between the input sensing unit TP and the light control layer PP, and may be formed of an adhesive material having excellent or suitable moisture permeability prevention properties. For example, the interlayer adhesive layer PIB may be formed by including polyisobutylene. The interlayer adhesive layer PIB may be arranged on the input sensing unit TP to prevent or reduce the corrosion of sensing electrodes of the input sensing unit TP. The display device DD-b of one or more embodiments includes the optical adhesive layer AP-a and the adhesive member AP formed from the resin composition RC of one or more embodiments, and the display device DD-b including the optical adhesive layer AP-a and the adhesive member AP may exhibit excellent or suitable reliability.

Hereinafter, referring to Examples and Comparative Examples, a resin composition according to one or more embodiments of the present disclosure and an adhesive member formed from the resin composition will be described in more detail. In addition, Examples shown are for illustrative purposes only to facilitate the understanding of the disclosure, and thus, the scope of the disclosure is not limited thereto.

### EXAMPLES

### 1. Synthesis of (Meth)Acrylate Copolymers

(Meth)acrylate copolymers of A-1 to A-3 which were provided to resin compositions of Examples and Comparative Examples were synthesized by the method described herein. The (meth)acrylate copolymers of A-1 to A-2 are dendritic polymers of Examples, and the (meth)acrylate copolymer of A-3 is a linear polymer of Comparative Examples.

### Synthesis of (Meth)Acrylate Copolymer A-1

To a circular flask equipped with a cooling tube, a dropping funnel, a nitrogen introduction tube, and a magnetic stirrer, 60 g of butyl acetate, 16 g of methyl methacrylate (MMA, a product of Tokyo Chemical Industry), 8.9 g of isobornyl methacrylate (IBXMA, a product of Tokyo Chemical Industry), 0.2 g of dimethyl 2,2′-azobis(2-methylpropionate) (V-601, a product of FUJIFILM Wako Pure Chemical), and 0.6 g of pentaerythritol tetrakis(3-mercaptobutylate) (KarenzMT PE1, a product of Resonac Co., Ltd.) were added to perform a reaction for 4 hours at 80° C. under a nitrogen stream to obtain a sample. Thereafter, the cooled sample was placed in methanol, re-precipitated, purified, and then vacuum-dried to obtain a (meth)acrylate copolymer A-1.

### Synthesis of (Meth)Acrylate Copolymer A-2

A (meth)acrylate copolymer A-2 was synthesized in substantially the same manner as in the synthesis of the (meth)acrylate copolymer A-1, except that 0.6 g of KarenzMT PE1 was changed to 1.6 g of KarenzMT PE1.

### Synthesis of (Meth)Acrylate Copolymer A-3

A (meth)acrylate copolymer A-3 was synthesized in substantially the same manner as in the synthesis of the (meth)acrylate copolymer A-1, except that 0.6 g of KarenzMT PE1 was not provided.

Table 1 shows a core portion and an arm portion which are included in each of the synthesized (meth)acrylate copolymers A-1 and A-2. In Table 1, ‘Core’ corresponds to the core portion, and ‘Arm’ corresponds to the arm portion. “-*” indicates a connected portion, and ‘ran’ refers to that left and right repeating units are randomly connected to each other. The (meth)acrylate copolymer A-2 includes a core portion and an arm portion, which may each independently be the same as those of the (meth)acrylate copolymer A-1.

TABLE 1

| | | |
|---|---|---|
| (Meth)acrylate copolymer | A-1 | 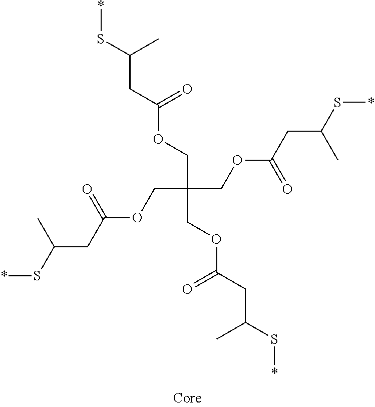 [SMILES: *SC(C)CC(=O)OCC(COC(=O)CC(C)S*)(COC(=O)CC(C)S*)COC(=O)CC(C)S*] |
| | | 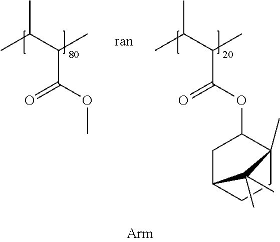 |
| | A-3 | 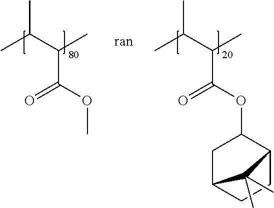 |

Referring to Table 1, it can be seen that the (meth)acrylate copolymer A-1 includes a core portion and an arm portion, and the core portion includes a polyfunctional thiol moiety. In addition, it can be seen that the (meth)acrylate copolymer A-1 includes a repeating unit represented by Formula 1 described above. As described above, the (meth)acrylate copolymer A-1 is a dendritic polymer according to one or more embodiments.

In contrast, it can be seen that the (meth)acrylate copolymer A-3 is a polymer including only an arm portion without a core portion, and does not include a thiol moiety. As described above, the (meth)acrylate copolymer A-3 is a linear polymer of Comparative Examples.

Table 2 describes materials and physical properties thereof, the materials used in the synthesis of the synthesized (meth)acrylate copolymers A-1, A-2, and A-3. The physical properties were measured by the methods described herein.

### Measurement of Molecular Weight and Polydispersity Index

A gel permeation chromatography (GPC) analysis device HLC-8420GPC, which is a product of TOSOH corporation, was used for the measurement. TSKgel SUPER HZM-N was used as a measurement column and tetrahydrofuran (THF) was used as a measurement solvent to obtain a weight average molecular weight value and a polydispersity index value by standard polystyrene (PS) conversion in a size exclusion chromatography (SEC) curve detected with a refractive index (RI) detector.

### Measurement of Glass Transition Temperature

A differential scanning calorimetry (DSC) device Photo-DSC 204 Phoenix, which is a product of NETZSCH, was used to measure a glass transition temperature under the condition of a temperature increase rate of 10 K/min. The results of the second scan result are recorded in Table 2.

TABLE 2

| | | | | | | Weight | | Glass | Number |
|---|---|---|---|---|---|---|---|---|---|
| | | | | Chain | | average | | transition | of |
| | | First | Second | transfer | | molecular | Polydispersity | temperature | binding |
| | | monomer | monomer | agent | Initiator | weight | index | [Tg, ° C.] | sites |
| (Meth)acrylate | A-1 | MMA | IBXMA | Karen | V-601 | 9000 | 1.4 | 90 | 4 |
| copolymer | | | | zMT | | | | | |
| | | | | PE1 | | | | | |
| | A-2 | MMA | IBXMA | Karen | V-601 | 22000 | 1.5 | 119 | 4 |
| | | | | zMT | | | | | |
| | | | | PE1 | | | | | |
| | A-3 | MMA | IBXMA | — | V-601 | 9000 | 1.5 | 118 | 0 |
| | | | | | | | | | (Linear) |

Referring to Table 2, the (meth)acrylate copolymers A-1 and A-2 have the number of binding sites (number of bonds) of 4, which corresponds to a dendritic polymer having a dendritic structure in which four monomer groups are branched from a core portion. The monomer group may correspond to the aforementioned arm portion. The (meth)acrylate copolymer A-3 has the number of binding sites (number of bonds) of 0 (zero), which corresponds to a linear polymer having a linear structure.

The (meth)acrylate copolymers A-1 and A-2 each have a weight average molecular weight of approximately (about) 1,000 to approximately (about) 50,000, which satisfies the weight average molecular weight of a dendritic polymer according to one or more embodiments. The (meth)acrylate copolymers A-1 and A-2 each have a polydispersity index of approximately (about) 1.0 to approximately (about) 3.0, which satisfies the polydispersity index of a dendritic polymer according to one or more embodiments. The (meth)acrylate copolymers A-1 and A-2 each have a glass transition temperature of approximately (about) 25° C. to approximately (about) 180° C., which satisfies the glass transition temperature of a dendritic polymer according to one or more embodiments.

### 2. Preparation and Evaluation of Resin Compositions

Resin compositions of Examples and Comparative Examples were each prepared using materials described in Tables 3. The materials described in Table 3 were each measured in respective amounts (g, gram) in a light-shielding glass vial and stirred using a roll mill at room temperature for 12 hours.

### Measurement of Shear Viscosity of Resin Composition

In Table 3, the shear viscosity of each of the resin compositions was measured by the JIS Z8803 method at a temperature of 25° C. The shear viscosity of each of the resin compositions was measured under the rate condition of 10 rpm using a viscometer TVE-25L (a product of TOKI SANGYO Co. Ltd.).

TABLE 3

| | | | | | | | | Comparative | Comparative |
|---|---|---|---|---|---|---|---|---|---|
| | | Example | Example | Example | Example | Example | Example | Example | Example |
| | | 1-1 | 1-2 | 1-3 | 1-4 | 1-5 | 1-6 | 1-7 | 1-8 |
| (Meth) | 4-HBA | 7 | 7 | 7 | 7 | 7 | 7 | 7 | |
| acrylate | 2-EHA | 55 | 55 | 55 | 55 | 55 | 55 | 55 | 20 |
| monomer | THF-A | 15 | 15 | 15 | 15 | 15 | 15 | 15 | 10 |
| | EHDG-AT | 12 | 12 | 12 | 12 | 12 | 12 | 12 | 40 |
| Urethane | UF-C051 | 3 | 3 | 3 | 3 | 3 | 3 | 3 | |
| (meth) | UF-C052 | 3 | 3 | 3 | 3 | 3 | 3 | 3 | |
| acrylate | UN6304 | 7 | 7 | 7 | 7 | 7 | 7 | 7 | 30 |
| oligomer | | | | | | | | | |
| Photoinitiator | Omnirad | 3 | 3 | 3 | 3 | 3 | 3 | 3 | |
| | 819 | | | | | | | | |
| | TPO-L | | | | | | | | 2 |
| (Meth) | A-1 | 1 | 3 | 5 | 10 | | | | |
| acrylate | A-2 | | | | | 5 | 10 | | |
| copolymer | A-3 | | | | | | | 10 | |

| | | | | | | | | |
|---|---|---|---|---|---|---|---|---|
| Shear viscosity | 15 | 18 | 21 | 30 | 24 | 39 | 28 | 148 |
| [25° C., mPa · s] | | | | | | | | |

### Data on the Materials of Table 3

4-HBA: 4-hydroxybutyl acrylate (a product of Osaka Organic Chemical Industry Ltd.)

2-EHA: 2-ethylhexyl acrylate (a product of Toagosei Co., Ltd.)

THF-A: Tetrahydrofurfuryl acrylate (a product of Kyoeisha Chemical Co., Ltd.)

EHDG-AT: 2-ethylhexyl-diglycol acrylate, (a product of Kyoeisha Chemical Co., Ltd.)

UF-C051: Urethane acrylate (weight average molecular weight 35000, a product of Kyoeisha Chemical Co., Ltd.)

UF-C052: Urethane acrylate (weight average molecular weight 10000, a product of Kyoeisha Chemical Co., Ltd.)

UN6304: Urethane acrylate (weight average molecular weight 10000, a product of Negami Chemical Industrial Co., Ltd.)

Omnirad 819: Phenylbis(2,4,6-trimethylbenzoyl) phosphine oxide (a product of IGM Resins Co.)

TPO-L: Ethyl(2,4,6-trimethylbenzoyl)phenyl phosphinate (a product of Chitec Technology)

In Table 3, the resin compositions of Examples 1-1 to 1-6 are each the resin composition according to one or more embodiments, and does not include a solvent. Each of the resin compositions of Examples 1-1 to 1-6 includes a urethane acrylate having a weight average molecular weight of approximately (about) 10,000 to approximately (about) 35,000, wherein the urethane acrylate satisfies the weight average molecular weight range (approximately (about) 5,000 to approximately (about) 100,000) of the urethane (meth)acrylate oligomer according to one or more embodiments.

Each of the resin compositions of Examples 1-1 to 1-6 includes the (meth)acrylate copolymer A-1 or A-2. As described above, the (meth)acrylate copolymers A-1 and A-2 correspond to a dendritic polymer according to one or more embodiments. In the resin compositions of Examples 1-1 to 1-4, based on the total weight of the resin composition, the weight of the (meth)acrylate copolymer A-1 is in the range of approximately (about) 0.5 wt % to approximately (about) 15 wt %. In the resin compositions of Examples 1-5 and 1-6, based on the total weight of the resin composition, the weight of the (meth)acrylate copolymer A-2 is in the range of approximately (about) 0.5 wt % to approximately (about) 15 wt %. In the resin compositions of Examples 1-1 to 1-6, the (meth)acrylate copolymers A-1 and A-2, which are dendritic polymers, satisfy the weight range of a dendritic polymer according to one or more embodiments.

The resin composition of Example 1-1 has a total weight of 106 g, and if 106 g is converted to 100 wt %, the weight of the (meth)acrylate copolymer in the resin composition of Example 1-1 is about 0.94 wt %. In the same manner, in the resin compositions of Examples 1-2 to 1-6, if the total weight of each of the resin compositions is converted to 100 wt %, the weight of the (meth)acrylate copolymers is respectively about 2.78 wt %, about 4.55 wt %, about 8.70 wt %, about 4.55 wt %, and about 8.70 wt %. In other words, the resin composition of Example 1-1 has a total weight of 106 g, which translates to 0.94 wt % of (meth)acrylate copolymer when converted to 100 wt %. Similarly, for the resin compositions of Examples 1-2 to 1-6, the (meth)acrylate copolymer weights are 2.78 wt %, 4.55 wt %, 8.70 wt %, 4.55 wt %, and 8.70 wt %, respectively, when each total weight is converted to 100 wt %.

The resin compositions of Comparative Examples 1-7 and 1-8 do not include a dendritic polymer according to one or more embodiments. The resin composition of Comparative Examples 1-7 includes a linear polymer.

Referring to the shear viscosity of Table 3, it can be seen that the resin compositions of Examples 1-1 to 1-6 each have a shear viscosity of approximately (about) 5 mPa-s to approximately (about) 50 mPa·s as measured by the JIS Z8803 method at a temperature of approximately (about) 25° C. The resin compositions of Examples 1-1 to 1-6 are each the resin composition according to one or more embodiments, and each include a monofunctional (meth)acrylate monomer, a urethane (meth)acrylate oligomer having a weight average molecular weight of approximately (about) 5,000 to approximately (about) 100,000, a dendritic polymer, and a photoinitiator. Therefore, it can be seen that the resin composition according to one or more embodiments exhibits low-viscosity properties.

Referring to the shear viscosity of Table 3, it can be seen that the resin composition of Comparative Example 1-8 has a shear viscosity of greater than approximately (about) 50 mPa·s as measured by the JIS Z8803 method at a temperature of approximately (about) 25° C. It can be seen that the resin composition of Comparative Example 1-8 does not include a dendritic polymer, and thus, exhibits a high shear viscosity. As described above, a resin composition having a shear viscosity of greater than approximately (about) 50 mPa-s is not easily discharged from a device such as a nozzle, and cannot be applied in a substantially uniform amount and/or to a substantially uniform thickness.

### 3. Preparation and Evaluation of Adhesive Member

Table 4 shows the evaluation of the storage modulus, the glass transition temperature, and the 180° peel force in adhesive members respectively formed from the resin compositions of Examples and Comparative Examples. Adhesive members of Examples 2-1 to 2-6 are respectively formed from the resin compositions of Examples 1-1 to 1-6. Adhesive members of Comparative Examples 2-7 and 2-8 are respectively formed from the resin compositions of Comparative Examples 1-7 and 1-8.

### Measurement of Storage Modulus and Glass Transition Temperature of Adhesive Member

On a release-treated PET film, an approximately (about) 500 μm-thick silicone rubber sheet having a circular hollow hole with an inner diameter of approximately (about) 8 mm was placed to provide about 28 μL of one of the resin compositions of Examples and Comparative Examples to the hollow hole. Thereafter, light was irradiated using LED lamps respectively having a peak at a wavelength of approximately (about) 365 nm and approximately (about) 395 nm such that the total amount of light was respectively approximately (about) 800 mJ/cm² and approximately (about) 400 mJ/cm². Thereafter, a PET film, which is the same as the above-described PET film was provided, and a glass substrate having a thickness of about 1 mm was provided on the PET film. From an upper portion of the glass substrate, light was irradiated using an LED lamp having a peak at a wavelength of approximately (about) 395 nm such that the total amount of light was approximately (about) 4000 mJ/cm², thereby obtaining a circular sample having a diameter of approximately (about) 8 mm and a thickness of approximately (about) 500 μm.

The obtained sample was provided for dynamic viscoelasticity measurement. The measurement was performed using MCR302 (a product of Anton-Paar) and under the conditions of a frequency of approximately (about) 1 Hz, a shear mode, a temperature of approximately (about) −50° C. to approximately (about) 80° C., and a temperature increase rate of approximately (about) 2° C./min. The storage modulus and the glass transition temperature at approximately (about) −20° C. confirmed by the measurement are recorded in Table 4. The glass transition temperature is a temperature recorded when a tan δ value was at a peak, and the tan δ is the ratio (G″/G′) of a loss modulus (G″) to a storage modulus (G′).

### Measurement of 180° Peel Force of Adhesive Member

On a 26 mm×76 mm soda-lime glass (a product of Central Glass Co., Ltd.), the resin compositions of Examples and Comparative Examples were each applied using a bar coater to a thickness of approximately (about) 50 μm. On the soda-lime glass on which the resin composition is applied, light was irradiated using LED lamps respectively having a peak at a wavelength of approximately (about) 365 nm and approximately (about) 395 nm such that the total amount of light was respectively approximately (about) 800 mJ/cm² and approximately (about) 400 mJ/cm². A PET film (A4360, a product of TOYOBO Co., Ltd.) having a size of 20 mm×150 mm was provided on the resin composition irradiated with the light, and bonded with a bonding pressure of approximately (about) 0.15 MPa. After the bonding, on (e.g., through) the PET film, light was irradiated using an LED lamp having a peak at a wavelength of approximately (about) 395 nm such that the total amount of light was approximately (about) 4000 mJ/cm², thereby obtaining a sample.

The peel force of the obtained sample was measured under a constant temperature environment of approximately (about) 25° C. or approximately (about) 60° C. using a universal testing machine (a product of Instron Corporation, a 5965 type or kind) at a rate of 300 mm/min such that the peel angle was 180°. An average value of about 50 mm peeling was obtained, and the obtained value was multiplied by 1.25 to record a peel force with respect to a width of 25 mm in Table 4.

TABLE 4

| | | | | | | | Comparative | Comparative |
|---|---|---|---|---|---|---|---|---|
| | Example | Example | Example | Example | Example | Example | Example | Example |
| | 2-1 | 2-2 | 2-3 | 2-4 | 2-5 | 2-6 | 2-7 | 2-8 |
| Storage | 0.142 | 0.155 | 0.175 | 0.275 | 0.171 | 0.224 | 0.326 | 0.034 |
| modulus | | | | | | | | |
| [−20° C., | | | | | | | | |
| MPa] | | | | | | | | |
| Glass | −39 | −37 | −37 | −35 | −38 | −36 | −31 | −45 |
| transition | | | | | | | | |
| temperature | | | | | | | | |
| [° C.] | | | | | | | | |
| 180° | 1060 | 1210 | 1400 | 2070 | 1500 | 1900 | 1720 | 10 |
| peel | | | | | | | | |
| force | | | | | | | | |
| [25° C., | | | | | | | | |
| gf/25 mm] | | | | | | | | |
| 180° | 500 | 560 | 660 | 1180 | 870 | 1070 | 690 | 5 |
| peel | | | | | | | | |
| force | | | | | | | | |
| [60° C., | | | | | | | | |
| gf/25 | | | | | | | | |
| mm] | | | | | | | | |

Referring to Table 4, it can be seen that the adhesive members of Examples 2-1 to 2-6 each have a storage modulus of approximately (about) 1 MPa or less at a temperature of approximately (about) −20° C., and a glass transition temperature of approximately (about) 0° C. or less. For example, it can be seen that the adhesive members of Examples 2-1 to 2-6 each have a glass transition temperature of approximately (about) −32° C. or less. It can be seen that the adhesive members of Examples 2-1 to 2-6 each have a 180° peel force of approximately (about) 800 gf/25 mm or greater at a temperature of approximately (about) 25° C. It can be seen that the adhesive members of Examples 2-1 to 2-6 each have a 180° peel force of approximately (about) 500 gf/25 mm to approximately (about) 1200 gf/25 mm at a temperature of approximately (about) 60° C. The adhesive members of Examples 2-1 to 2-6 are each formed from the resin compositions according to one or more embodiments. Therefore, it can be seen that an adhesive member formed from a resin composition according to one or more embodiments exhibits excellent or suitable flexibility and excellent or suitable adhesion reliability.

Referring to Table 4, it can be seen that the adhesive member of Comparative Example 2-7 has a glass transition temperature of approximately (about) −31° C., thereby exhibiting a glass transition temperature higher than that of each of the adhesive members of Examples 2-4 and 2-6. The adhesive member of Comparative Example 2-7 is formed from the resin composition of Comparative Example 1-7, and as described with reference to Table 3, the resin composition of Comparative Example 1-7 does not include a dendritic polymer, but includes a linear polymer. The adhesive members of Examples 2-4 and 2-6 are respectively formed from the resin compositions of Examples 1-4 and 1-6, and the resin compositions of Examples 1-4 and 1-6 and Comparative Example 1-7 include the same weight (i.e., 10 g) of a (meth)acrylate copolymer (i.e., a dendritic polymer or a linear polymer). The adhesive member of Comparative Example 2-7, which exhibits a relatively high glass transition temperature, is not easily repeatedly folded and unfolded in a relatively low-temperature environment. Therefore, it can be seen that an adhesive member formed from a resin composition including a linear polymer without including a dendritic polymer is not suitable for a flexible display device.

Referring to Table 4, it can be seen that the adhesive member of Comparative Example 2-8 has a storage modulus of approximately (about) 1 MPa or less at a temperature of approximately (about) −20° C., and a glass transition temperature of approximately (about) 0° C. or less. However, it can be seen that the adhesive member of Comparative Example 2-8 has a 180° peel force of much less than approximately (about) 800 gf/25 mm at a temperature of approximately (about) 25° C. The adhesive member of Comparative Example 2-8 is formed from the resin composition of Comparative Example 1-8, and as described with reference to Table 3, the resin composition of Comparative Example 1-8 does not include a dendritic polymer. Accordingly, it can be seen that the adhesive member of Comparative Example 2-8 exhibits a low 180° peel force.

A display device of one or more embodiments includes an adhesive member between a display panel and a window, and the adhesive member may include a polymer derived from a resin composition of one or more embodiments of the present disclosure. The adhesive member may be formed by curing the resin composition of one or more embodiments.

The resin composition of one or more embodiments may include a monofunctional (meth)acrylate monomer, a urethane (meth)acrylate oligomer having a weight average molecular weight of approximately (about) 5,000 to approximately (about) 100,000, a dendritic polymer, and a photoinitiator. Accordingly, the resin composition of one or more embodiments may exhibit low-viscosity properties before being cured, and may exhibit excellent or suitable flexibility and excellent or suitable adhesion reliability after being cured. The adhesive member formed from the resin composition of one or more embodiments and the display device including the adhesive member may exhibit excellent or suitable reliability. In other words, the resin composition in one or more embodiments may include a monofunctional (meth)acrylate monomer, a urethane (meth)acrylate oligomer with a weight average molecular weight of 5,000 to 100,000, a dendritic polymer, and a photoinitiator. This composition may exhibit low viscosity before curing and excellent flexibility and adhesion reliability after curing. Consequently, the adhesive member formed from this resin composition and the display device including it may demonstrate excellent reliability.

A resin composition of one or more embodiments includes a dendritic polymer, and thus, may exhibit low-viscosity properties.

An adhesive member of one or more embodiments includes a polymer derived from the resin composition of one or more embodiments, and thus, may exhibit excellent or suitable flexibility and excellent or suitable adhesion reliability.

A display device of one or more embodiments includes the adhesive member of one or more embodiments, and thus, may exhibit excellent or suitable reliability.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present application and unless otherwise defined, the terms “use,” “using,” and “used” may be considered synonymous with the terms “utilize,” “utilizing,” and “utilized,” respectively.

As utilized herein, the terms “substantially,” “about,” “approximately (about),” or similar terms are used as terms of approximation and not as terms of degree, and are intended to account for the inherent deviations in measured or calculated values that would be recognized by those of ordinary skill in the art. “About” or “approximately (about)” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” or “approximately (about)” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this disclosure, including the claims, to expressly recite any sub-range subsumed within the ranges expressly recited herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

The adhesive member-manufacturing apparatus, the light-emitting element, the electronic devices/apparatus, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the present disclosure has been described with reference to example embodiments of the present disclosure, it will be understood by those skilled in the art that one or more suitable modifications and changes in form and details may be made therein without departing from the spirit and scope of the disclosure as set forth in the appended claims and equivalents thereof.

Accordingly, the technical scope of the disclosure is not intended to be limited to the contents set forth in the detailed description of the disclosure, but is intended to be defined by the appended claims and equivalents thereof.

What is claimed is:

1. A resin composition comprising:
one or more monofunctional (meth)acrylate monomers;
a urethane (meth)acrylate oligomer having a weight average molecular weight of about 5,000 to about 100,000;
a dendritic polymer; and
at least one photoinitiator comprising a radical polymerization initiator.

2. The resin composition of claim 1, wherein based on 100 wt % of a total weight of the resin composition, a weight of the dendritic polymer is in a range of about 0.5 wt % to about 15 wt %.

3. The resin composition of claim 1, wherein a glass transition temperature of the dendritic polymer is in a range of about 25° C. to about 180° C.

4. The resin composition of claim 1, wherein a weight average molecular weight of the dendritic polymer is in a range of about 1,000 to about 50,000.

5. The resin composition of claim 1, wherein the dendritic polymer comprises a repeating unit represented by Formula 1: 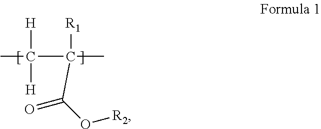
in Formula 1,
R₁ being hydrogen or a methyl group, and
R₂ being an alkyl group having 1 to 20 carbon atoms.

6. The resin composition of claim 1, wherein the dendritic polymer comprises a polyfunctional thiol moiety.

7. The resin composition of claim 1, wherein a polydispersity index of the dendritic polymer is in a range of about 1.0 to about 3.0.

8. The resin composition of claim 1, wherein the resin composition does not comprise a solvent.

9. The resin composition of claim 1, wherein the resin composition has a shear viscosity measured by the JIS Z8803 method at a temperature of 25° C. in a range of about 5 mPa-s to about 50 mPa·s.

10. The resin composition of claim 1, wherein after photo-curing, the photo-cured resin composition has a storage modulus of about 1 MPa or less at a frequency of about 1 Hz and a temperature of about −20° C.

11. The resin composition of claim 1, wherein after photo-curing, the photo-cured resin composition has a 180° peel force of about 800 gf/25 mm or greater with respect to at least one of a glass substrate or a polymer substrate at a temperature of about 25° C.

12. The resin composition of claim 1, wherein after photo-curing, the photo-cured resin composition has a glass transition temperature of about 0° C. or less.

13. The resin composition of claim 1, wherein the one or more monofunctional (meth)acrylate monomers comprise at least one of 4-hydroxybutyl acrylate, 2-ethylhexyl acrylate, tetrahydrofurfuryl acrylate, or 2-ethylhexyl-diglycol acrylate.

14. The resin composition of claim 1, wherein the resin composition is provided by an inkjet printing method or a dispensing method.

15. An adhesive member comprising a polymer derived from a resin composition comprising at least one monofunctional (meth)acrylate monomer, a urethane (meth)acrylate oligomer having a weight average molecular weight of about 5,000 to about 100,000, a dendritic polymer, and at least one photoinitiator comprising a radical polymerization initiator.

16. The adhesive member of claim 15, wherein the adhesive member has a storage modulus of about 1 MPa or less at a frequency of about 1 Hz and a temperature of about −20° C.

17. The adhesive member of claim 15, wherein the adhesive member has a 180° peel force of about 800 gf/25 mm or greater with respect to at least one of a glass substrate or a polymer substrate at a temperature of about 25° C.

18. The adhesive member of claim 15, wherein the adhesive member has a glass transition temperature of about 0° C. or less.

19. The adhesive member of claim 15, wherein based on 100 wt % of a total weight of the resin composition, a weight of the dendritic polymer is in a range of about 0.5 wt % to about 15 wt %.

20. The adhesive member of claim 15, wherein a weight average molecular weight of the dendritic polymer is in a range of about 1,000 to about 50,000.

21. The adhesive member of claim 15, wherein the dendritic polymer comprises a repeating unit represented by Formula 1: 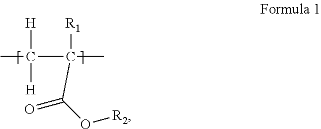
in Formula 1,
R₁ being hydrogen or a methyl group, and
R₂ being an alkyl group having 1 to 20 carbon atoms.

22. The adhesive member of claim 15, wherein the dendritic polymer comprises a polyfunctional thiol moiety.

23. The adhesive member of claim 15, wherein the dendritic polymer comprises a (meth)acrylate copolymer, wherein the (meth)acrylate copolymer has a polydispersity index of about 1.0 to about 3.0.

24. The adhesive member of claim 15, wherein the resin composition has a shear viscosity of about 5 mPa·s to about 50 mPa·s as measured by the JIS Z8803 method at a temperature of about 25° C.

25. A display device comprising:
a display panel;
a window on the display panel; and
an adhesive member between the display panel and the window, and comprising a polymer derived from a resin composition comprising at least one monofunctional (meth)acrylate monomer, a urethane (meth)acrylate oligomer having a weight average molecular weight of about 5,000 to about 100,000, a dendritic polymer, and at least one photoinitiator comprising a radical polymerization initiator.

26. The display device of claim 25, wherein the adhesive member has a storage modulus of about 1 MPa or less at a frequency of about 1 Hz and a temperature of about −20° C.

27. The display device of claim 25, wherein the adhesive member has a 180° peel force of about 800 gf/25 mm or greater with respect to at least one of a glass substrate or a polymer substrate at a temperature of about 25° C.

28. The display device of claim 25, wherein the adhesive member has a glass transition temperature of about 0° C. or less.

29. The display device of claim 25, wherein based on 100 wt % of a total weight of the resin composition, a weight of the dendritic polymer is in a range of about 0.5 wt % to about 15 wt %.

30. The display device of claim 25, wherein a weight average molecular weight of the dendritic polymer is in a range of about 1,000 to about 50,000.

31. The display device of claim 25, wherein the dendritic polymer comprises a repeating unit represented by Formula 1: 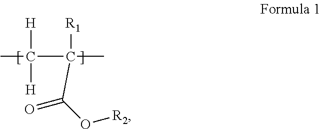
in Formula 1,
R₁ being hydrogen or a methyl group, and
R₂ being an alkyl group having 1 to 20 carbon atoms.

32. The display device of claim 25, wherein the dendritic polymer comprises a polyfunctional thiol moiety.

33. The display device of claim 25, wherein the dendritic polymer comprises a (meth)acrylate copolymer, wherein the (meth)acrylate copolymer has a polydispersity index of about 1.0 to about 3.0.

34. The display device of claim 25, wherein the resin composition has a shear viscosity of about 5 mPa·s to about 50 mPa·s as measured by the JIS Z8803 method at a temperature of about 25° C.

35. The display device of claim 25, further comprising an input sensing unit between the display panel and the window, wherein the adhesive member is between the display panel and the input sensing unit or between the input sensing unit and the window.
